(19) United States
(12) Patent Application Publication
(10) Pub. No.: US 2026/0173990 A1
(43) Pub. Date: Jun. 25, 2026

(54) TOOL AND TOOL HOLDER FOR A ROTARY LAND PREPARATION IMPLEMENT AND VEHICLE THEREOF

(71) Applicant: Fecon, LLC, Lebanon, OH (US)

(72) Inventors: Tyler Rand Smith, Morrow, OH (US); Jeffrey Thomas Stanley, Lebanon, OH (US); Steven Keith Watson, III, Lebanon, OH (US)

(21) Appl. No.: 18/991,352

(22) Filed: Dec. 21, 2024

(51) Int. Cl. A01B 35/28; A01B 27/00; A01B 29/04; A01G 3/00

(52) U.S. Cl. CPC A01B 35/28; A01B 27/005; A01B 29/041; E02F 9/2866

(57) ABSTRACT

A land preparation implement includes a rotatable drum assembly that includes a tool assembly. The tool assembly includes a tool holder and a tool. The tool includes a plurality of cleats. The tool holder includes a plurality of cleat supports. The cleats and the cleat supports cooperate to facilitate releasable coupling of the tool to the tool holder.

### TECHNICAL FIELD

A tool and a tool holder are provided for rotary land preparation implements, such as cutting, grinding, mulching, and/or shredding tools. The tool has a plurality of cleats and the tool holder includes cleat supports that facilitate releasable coupling therebetween.

### BACKGROUND

Land preparation and clearing machines, such as forestry mulchers and land clearing equipment, can be utilized for vegetation management, clearing land, creating paths, and otherwise removing debris, brush, trees, vegetation, soil, concrete, asphalt, rock, and/or other materials, making the land suitable for further development or use. To carry out these tasks, such machines can include a land preparation implement operable to mulch, cut, shred, and/or grind vegetation, brush, trees, stumps, soil, concrete, asphalt, rock, and other materials.

The land preparation implement can be integrally or releasably attached to a vehicle such as a tractor or skid steer, for example, to facilitate articulation and movement of the implement with respect to the vegetation. Often, the vehicle may be a multi-purpose vehicle having the capability to be fitted with any of a variety of implements suitable for other tasks.

### BRIEF DESCRIPTION OF THE DRAWINGS

Various embodiments will become better understood with regard to the following description, appended claims and accompanying drawings wherein:

FIG. 1 is a side isometric view depicting a vehicle that includes a rotary land preparation implement having a rotatable drum assembly;

FIG. 2 is front view of the vehicle of FIG. 1;

FIG. 3 is a partially exploded cutaway view of the rotatable drum assembly of FIG. 1 with one tool assembly shown associated therewith;

FIG. 4 is a front upper isometric view of the tool assembly of FIG. 3 that includes a tool holder and a tool, in accordance with one embodiment;

FIG. 5 is an exploded front upper isometric view of the tool assembly of FIG. 4;

FIG. 6 is a rear upper isometric view of the tool of FIG. 4;

FIG. 7 is a rear lower isometric view of the tool of FIG. 6;

FIG. 8 is a cross sectional view taken along the line 8-8 in FIG. 7;

FIG. 9 is a front left upper isometric view of the tool holder of FIG. 4;

FIG. 10 is a rear left isometric view of the tool holder of FIG. 4;

FIG. 11 is a front right upper isometric view of the tool holder of FIG. 4;

FIG. 12 is a rear right isometric view of the tool holder of FIG. 4;

FIG. 13 is a partially exploded isometric view of the tool being installed on the tool holder;

FIG. 14 is a partially exploded isometric view of the tool being further installed on the tool holder relative to FIG. 13;

FIG. 15 is a cross sectional view taken along the line 15-15 in FIG. 14;

FIG. 16 is a cross sectional view taken along the line 16-16 in FIG. 14;

FIG. 17 is a partially exploded isometric view of the tool being further installed on the tool holder relative to FIG. 14;

FIG. 18 is a cross sectional view taken along the line 18-18 in FIG. 17;

FIG. 19 is a cross sectional view taken along the line 19-19 in FIG. 17;

FIG. 20 is an isometric view of the tool installed on the tool holder;

FIG. 21 is a cross sectional view taken along the line 21-21 in FIG. 20;

FIG. 22 is a cross sectional view taken along the line 22-22 in FIG. 20;

FIG. 23 is a cross sectional view taken along the line 23-23 in FIG. 4;

FIG. 24 is a front upper isometric view of a tool assembly having a tool holder and a tool, in accordance with another embodiment;

FIG. 25 is a front upper isometric view of the tool holder of FIG. 24;

FIG. 26 is a rear upper isometric view of the tool of FIG. 24;

FIG. 27 is a front upper isometric view of a tool assembly having a tool holder and a tool, in accordance with another embodiment;

FIG. 28 is a front upper isometric view of the tool holder of FIG. 27;

FIG. 29 is a rear upper isometric view of the tool of FIG. 27;

FIG. 30 is a front upper isometric view of a tool assembly having a tool holder and a tool, in accordance with yet another embodiment;

FIG. 31 is a front upper isometric view of a tool assembly having a tool holder and a tool, in accordance with still yet another embodiment;

FIG. 32 is a front upper isometric view of a tool assembly that includes a tool holder and a tool, in accordance with another embodiment;

FIG. 33 is an exploded front upper isometric view of the tool assembly of FIG. 32;

FIG. 34 is a rear upper isometric view of the tool of FIG. 32;

FIG. 35 is a rear lower isometric view of the tool of FIG. 32;

FIG. 36 is an upper isometric view of the tool of FIG. 32;

FIG. 37 is a cross sectional view taken along the line 37-37 in FIG. 36;

FIG. 38 is a front left upper isometric view of the tool holder of FIG. 32;

FIG. 39 is a rear left isometric view of the tool holder of FIG. 32;

FIG. 40 is another front upper isometric view of the tool assembly of FIG. 31;

FIG. 41 is a cross sectional view taken along the line 41-41 in FIG. 40;

FIG. 42 is a cross sectional view taken along the line 42-42 in FIG. 40;

FIG. 43 is a rear upper isometric view of a tool, in accordance with another embodiment;

FIG. 44 is a rear lower isometric view of the tool of FIG. 43;

FIG. 45 is a rear upper isometric view of a tool, in accordance with yet another embodiment;

FIG. 46 is a rear lower isometric view of the tool of FIG. 45;

FIG. 47 a front left upper isometric view of a tool holder, in accordance with another embodiment;

FIG. 48 is a front right upper isometric view of the tool holder of FIG. 47; and

FIG. 49 is a front upper isometric view of a tool assembly, in accordance with yet another embodiment.

### DETAILED DESCRIPTION

The present disclosure is generally directed to land preparation and clearing machines (“land preparation machines”) and their corresponding implements that are generally designed to cut, grind, mulch, shred, clear, mill, and/or mix trees, brush, ground cover, vegetation, debris, asphalt, concrete, and/or soil. The land preparation machines and their corresponding implements can comprise a variety of vehicles, including but not limited to skid steer vehicles, forestry machines and vehicles, PTO tractors, farm tractors, and/or any other known vehicles and can have corresponding implements compatible with land preparation and clearing. Such land preparation machines can prepare the surface and subsurface of the earth. As used herein, the phrases “land preparation and clearing” and “land preparation” will mean any land preparation and clearing operations, including but not limited to forestry operations such as cutting, grinding, mulching, shredding, clearing, milling, and/or mixing trees, brush, ground cover, vegetation, debris, rock, asphalt, concrete, and/or soil. As used herein, “feed material” describes trees, brush, ground cover, vegetation, debris, rock, asphalt, concrete, and/or soil produced from such land preparation and clearing operations, including but not limited to forestry operations such as clearing land, cutting and/or mulching trees, and/or preparing land surfaces (e.g., creating paths).

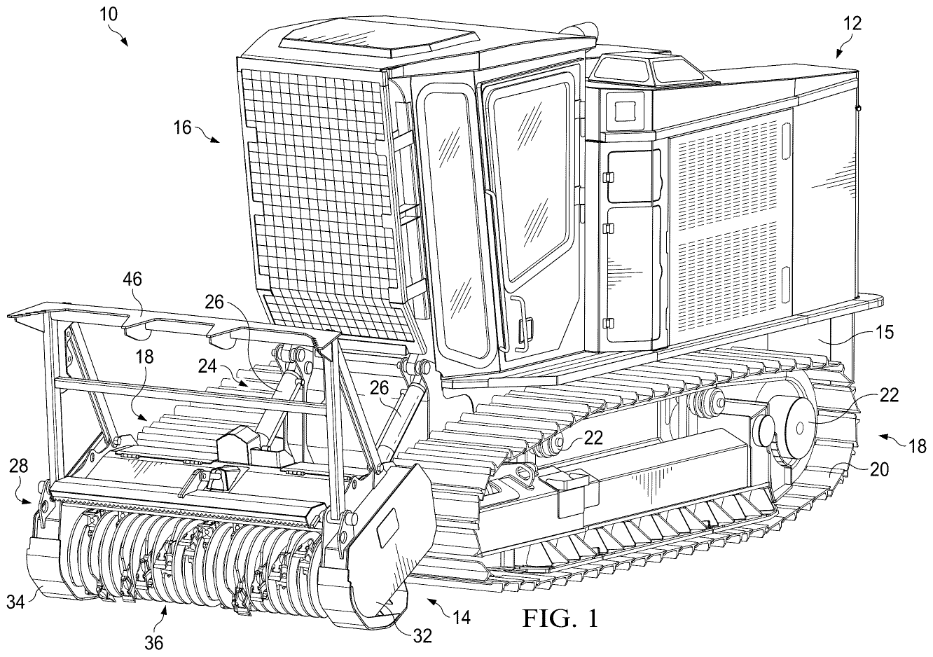

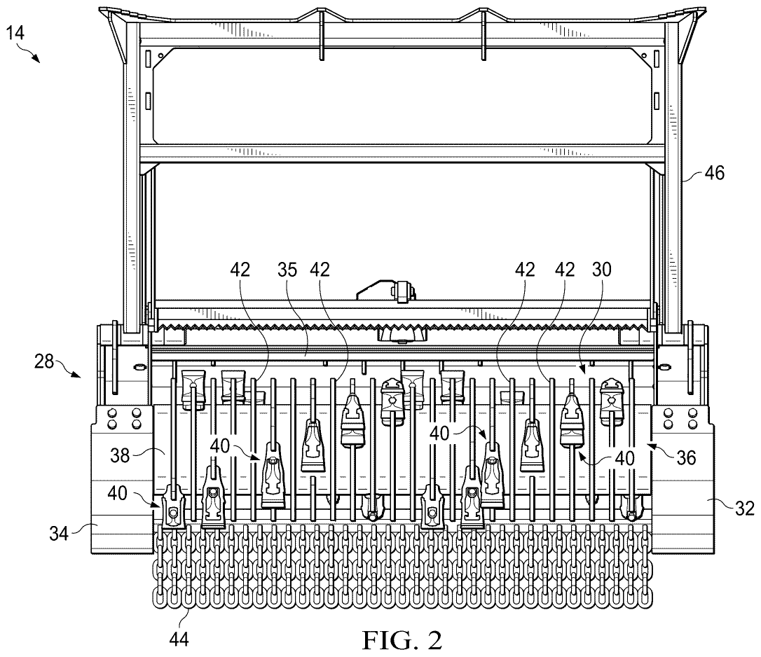

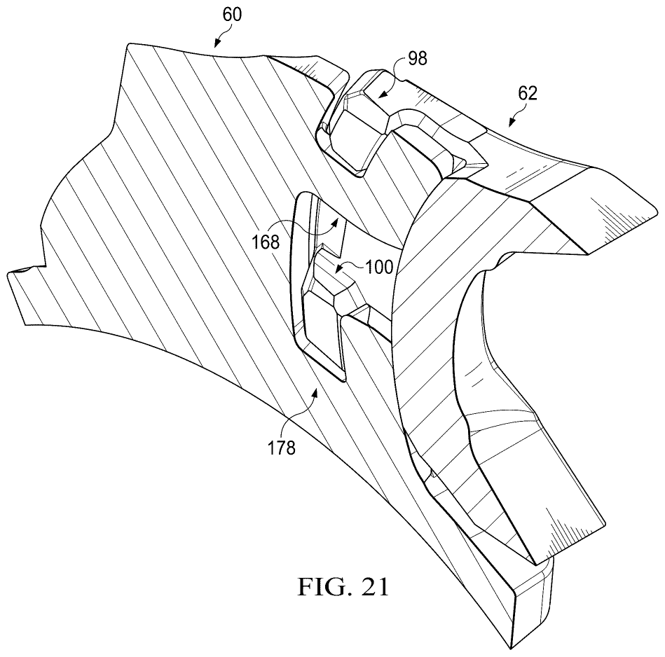

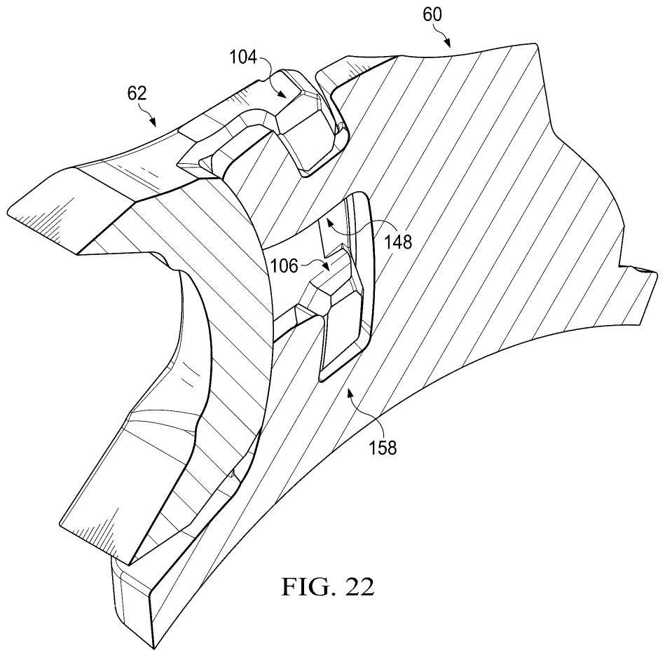

In connection with the views and examples of FIGS. 1-49, wherein like numbers indicate the same or corresponding elements throughout the views, FIGS. 1 and 2 illustrate a land preparation machine 10 that can include a vehicle 12 (e.g., a forestry vehicle) and a land preparation implement 14 attached to the vehicle 12. In this illustrative embodiment, the vehicle 12 is a skid steer vehicle suitable for off-road travel, and includes a body 15 that includes a passenger compartment 16 as well as a pair of track assemblies 18 that each include a track 20 that is routed around, and driven by, track drive wheels 22 that are rotatably coupled with the body 15. In an alternative embodiment, the vehicle 12 can include tires that may or may not accommodate all-terrain tracks. The vehicle 12 can also include a lift assembly 24 for vertically positioning the land preparation implement 14. The lift assembly 24 can include one or more lift arms 26 that are coupled with the land preparation implement 14 and can be hydraulically powered or electrically powered. Controls (not shown) can be provided for controlling the lift assembly 24, including the lift arms 26, as well as for controlling the operation of the track assembly 18 and the land preparation implement 14.

While the vehicle 12 is shown to be a skid steer vehicle, other suitable vehicles with capability for powering and utilizing a hydraulic motor attachment or tool (e.g., such as land preparation implement 14) are contemplated, such as other forestry vehicles, mini-track loaders, excavators, backhoes, PTO tractors, farm tractors, and/or any other known vehicles and their corresponding implements compatible with land preparation and clearing. Further examples of suitable skid steer vehicles are shown and described in U.S. Pat. Nos. 4,168,757 and 4,209,071, the entire disclosures of which are hereby incorporated by reference herein. In some embodiments, the vehicle 12 can be controlled remotely or through an autonomous control system.

The land preparation implement 14 can be removably connectable to the lift arms 26. The connection between the land preparation implement 14 (or any other attachment) and the lift arms 26 can be accomplished in any of a variety of manners. For example, receptacles (not shown) can be provided on a rear portion of the land preparation implement 14 to facilitate a connection with the lift arms 26 from the vehicle 12. In particular, such flanges and/or other rear portions of the land preparation implement 14 may define one or more bolt holes for receiving connector bolts (not shown). In certain embodiments, the land preparation implement 14 can include a hydraulic supply connection for receiving an operating supply of hydraulic fluid from a pump within the vehicle to power the land preparation implement 14, and a hydraulic return connection for returning hydraulic fluid to a tank within the vehicle 12. The hydraulic supply and return connections may comprise conventional quick-disconnect connections as known to one of ordinary skill in the art. In such embodiments, a hydraulic cooler may be provided to maintain the supply of hydraulic fluid at a desired temperature and viscosity. In such embodiments, the hydraulic cooler may be mounted to the vehicle 12.

It can be understood that, in certain embodiments, the land preparation implement 14 may be fixedly attached to the vehicle 12. However, it will be appreciated that in certain embodiments, a land preparation implement may be a stand-alone machine, such as a walk-behind land preparation implement. Also, it is understood that other hydraulically-operated rotary mowing or cutting attachments may be utilized with principles of one or more of the embodiments shown and described herein, integral with or detachable from vehicle 12, and/or separately from or in combination with the land preparation implement 14. Other configurations are also possible, such as, for example, where the fluid pump and tank are located at other locations. Connection, powering, and movement of the land preparation implement 14 can be accomplished with various configurations, such as those described in U.S. Pat. Nos. 4,148,366, and 5,813,792, for example, which are hereby incorporated herein by reference.

Still referring to FIGS. 1 and 2, the land preparation implement 14 can include a housing 28 having right and left end caps 32, 34, respectively, but it will be appreciated that other types of first and second ends may be provided. As illustrated in FIG. 2, the housing 28 can further include a framework 35 that can extend between and be connected to each of the right and left end caps 32, 34. The land preparation implement 14 may further include a rotatable drum assembly 36 movably (e.g., rotatably) connected to and between the right and left end caps 32, 34 within a chamber 30. In some embodiments, the right and left end caps 32, 34 may be integral with the housing 28. The rotatable drum assembly 36 can define a longitudinal axis and can include a rotatable drum 38. It is to be appreciated that although the rotatable drum 38 is shown to be substantially cylindrical, non-cylindrical rotatable drums are also contemplated.

The rotatable drum assembly 36 can also include a plurality of tool assemblies 40 that are responsible for clearing the feed material in front of the rotatable drum assembly 36. The tool assemblies 40 can be disposed along an outer perimeter of the rotatable drum 38 and longitudinally spaced from each other. The tool assemblies 40 can be arranged in a helical pattern to optimize the performance of the tool assemblies 40 when clearing the feed material. The tool assemblies 40 can comprise any of a variety of suitable cutters, grinders, mixers, and/or tools and any combination thereof for cutting, grinding, mulching, shredding, clearing, milling, and/or mixing the feed material. Examples of various tool assemblies arranged on a rotatable drum are illustrated in U.S. Publication No. 2009/0050341 A1 which is incorporated by reference herein in its entirety.

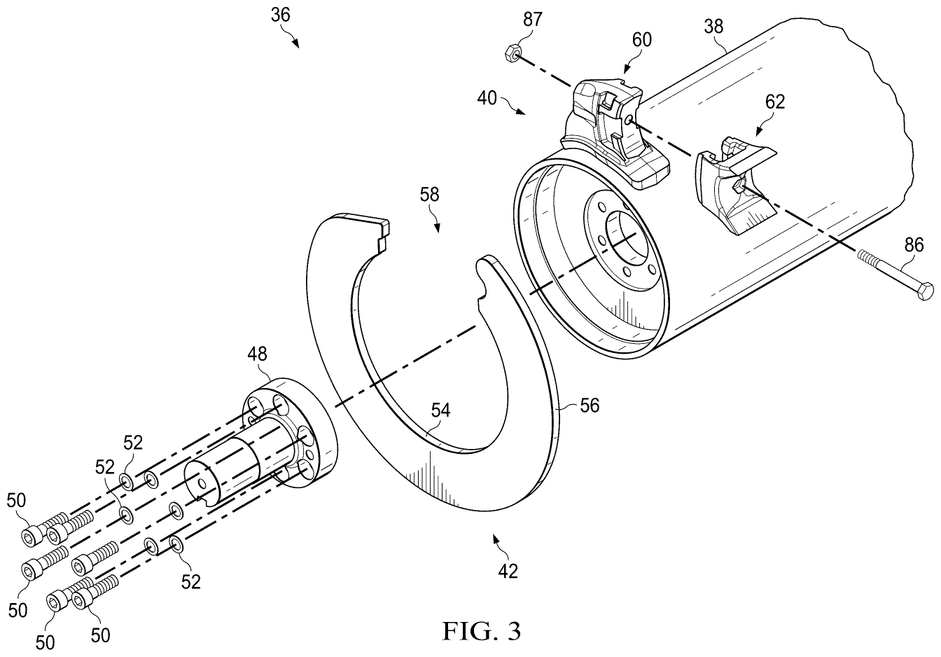

The rotatable drum assembly 36 can include plurality of depth control rings 42 (FIG. 3) that can be coupled to, and can extend radially outwardly from, the rotatable drum 38. The depth control rings 42 can be longitudinally spaced from each other along the length of the rotatable drum 38. Each depth control ring 42 can be aligned with one of the tool assemblies 40 and can have height that is less than the overall height of the tool assembly 40 that is aligned therewith. The difference in height between the tool assembly 40 and the depth control ring 42 can define a cutting depth for the tool assembly 40. The height of the depth control rings 42 can be selected to achieve a desired cutting depth and is typically between about 20% and about 80% of the overall height of the tool assembly 40, and more specifically can be between about 30% and about 60% of the overall height of the tool assembly 40. Various additional examples of depth control rings are disclosed in U.S. Patent Publication No. 2017/0079219 A1 which is incorporated by reference herein in its entirety.

During operation of the land preparation machine 10 and the land preparation implement 14, the lift arms 26 can be raised and lowered (via the controls) to raise and lower the land preparation implement 14 relative to the feed material being removed by the tool assemblies 40. The housing 28 can also include a plurality of chains 44 held in place by a chain rod (not shown) extending substantially across the width of the housing 28 from the right end cap 32 to left end cap 34, where the chain rod may be retained without welding or tapping.

The land preparation implement 14 can include a guard assembly 46 that extends upwardly from the framework 35 of the housing 28. In certain embodiments, the guard assembly 46 can include a gauge (not shown) that facilitates visual measurements for widths of, for example, trees and other vegetation. For example, in one embodiment, a center of the gauge may have a zero reading and distance markings may be provided in both directions extending laterally therefrom, where the values of such distance markings increase as the distance from the center of the gauge increases. By aligning, for example, trees or other vegetation with the center, a driver or operator can make a real time estimation to determine whether the trees or other vegetation is too large for the land preparation implement 14. The gauge can be applied to the guard assembly 46 by any suitable manner, such as printing distance markings thereon or attaching a separately formed gauge thereto, such that the gauge can be viewable by the driver or operator of the land preparation machine 10.

Referring now to FIG. 3, the rotatable drum assembly 36 can include an axle hub 48 that extends longitudinally from one end of the rotatable drum 38. The rotatable drum assembly 36 can include another axle hub (not shown) that is disposed at an opposite end of the rotatable drum 38 and is similar to the axle hub 48 shown in FIG. 3. For purposes of illustration, the axle hub 48 shown in FIG. 3 will now be described but can be understood to be representative of both of the axle hubs (e.g., 48). The axle hub 48 can be releasably coupled to the rotatable drum 38 by a plurality of fasteners 50. A locking washer 52, locking pin, or other suitable mechanism can be used along with one or more of the fasteners 50 to ensure firm securement of the axle hub 48 to the rotatable drum 38.

The rotatable drum assembly 36 can be operably coupled with a motor (not shown), that facilitates selective rotation of the rotatable drum 38. The motor can rotate the rotatable drum 38, and thus the plurality of tool assemblies 40, at an appropriate speed for the land preparation being performed (e.g., at speeds of between about 100 RPM and about 3000 RPM). The motor can be operably coupled with the rotatable drum 38 by a drive belt (not shown) or by being directly connected to the rotatable drum 38 or one of the axle hubs 48. In one embodiment, the motor can be a hydraulic motor, such as a hydraulic piston motor. In another embodiment, the motor can be an electrically driven motor. It is to be appreciated that the motor can be any of a variety of suitable alternative motors that facilitate operation of the rotatable drum 38. Various examples of hydraulically driven land preparation machinery are disclosed U.S. Patent Publication No. 2006/0032222 which is incorporated by reference herein in its entirety herein.

Still referring to FIG. 3, one of the depth control rings 42 is illustrated and will now be described and can be understood to be representative of the other depth control rings 42 of the rotatable drum assembly 36. The depth control ring 42 can include an inner perimeter 54 and an outer perimeter 56. The height of the depth control ring 42 can be defined as the distance between the inner and outer perimeters 54, 56. The inner perimeter 54 can be coupled to the rotatable drum 38 either through fixed attachment (e.g., welded, epoxied, braised or bonded) or releasable attachment (e.g., with fasteners). The inner perimeter 54 can be contoured in a similar manner as the rotatable drum 38 to facilitate effective mating therebetween when attaching the depth control ring 42 to the rotatable drum 38. The depth control ring 42 can define a slot 58 that can accommodate the tool assembly 40. In an alternative embodiment, the tool assembly 40 can be coupled to the depth control ring 42.

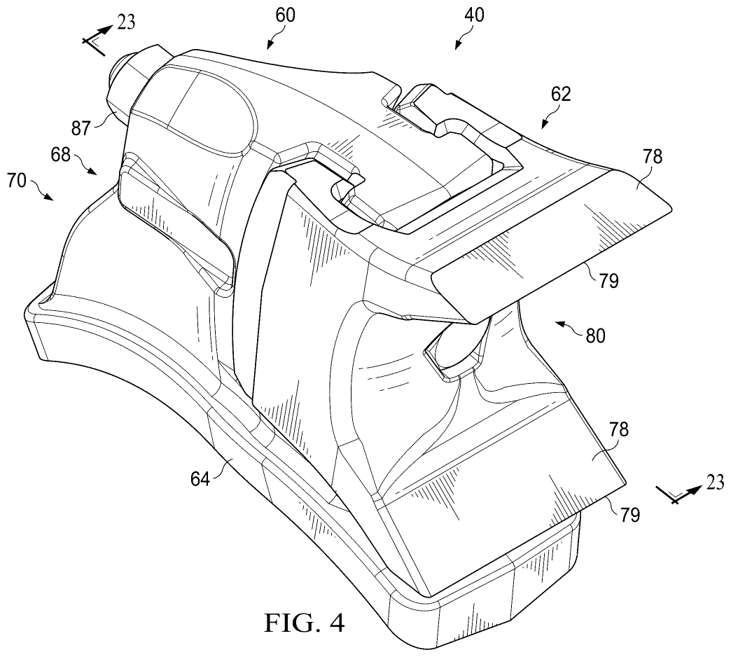

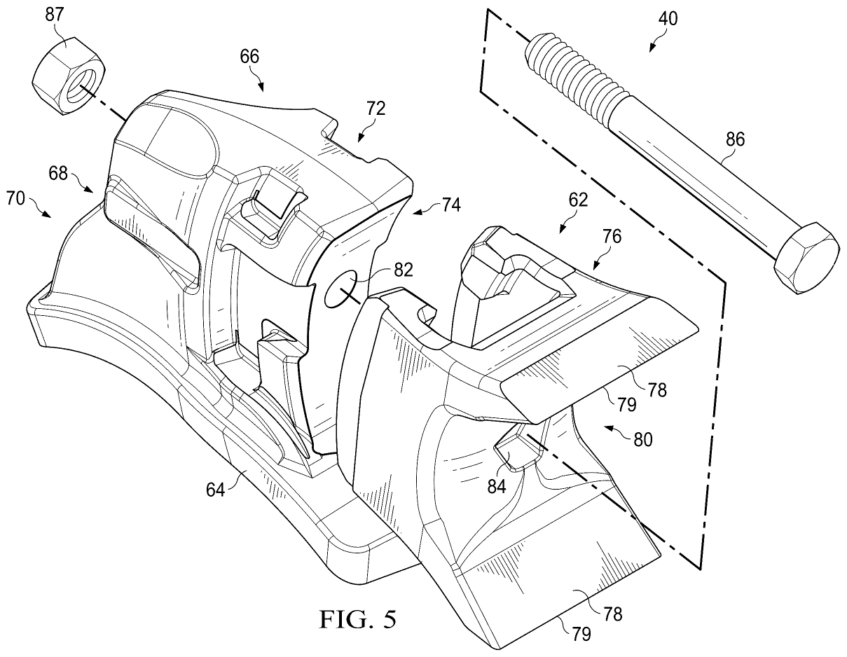

Referring now to FIGS. 4-23, one of the tool assemblies 40 is shown and will now be described and can be understood to be representative of other tool assemblies 40 on the rotatable drum 38. As illustrated in FIGS. 4 and 5, the tool assembly 40 can include a tool holder 60 and a land preparation tool 62 (hereinafter “the tool 62”) that is releasably coupled with the tool holder 60 such that the tool 62 is selectively attachable thereto. As illustrated in FIG. 5, the tool holder 60 can include a base flange 64 and a main body 66 that extends upwardly from the base flange 64. The main body 66 can include a rear portion 68 disposed at a rear end 70 of the tool holder 60 and a tool interface pillar 72 disposed at a front end 74 of the tool holder 60 and extending from the rear portion 68. The tool holder 60 can be attached to the rotatable drum 38 via the base flange 64. The base flange 64 can be attached via welding, brazing, or any of a variety of suitable alternative attachment methods. The base flange 64 can be contoured to mate appropriately with the rotatable drum 38 for effective attachment thereto. In one embodiment, the tool holder 60 can be formed of a unitary one-piece construction such as through a casting and machining process.

The tool 62 can include a main body 76 and a pair of blades 78 that extend from the main body 76 and have a leading edge 79 that is substantially flat (e.g., an axe configuration). The blades 78 can be disposed at a front end 80 of the tool 62 such that they are available to contact and cut the feed material during rotation of the rotatable drum assembly 36. The blades 78 can be vertically spaced from each other and the tool 62 can be arranged on the tool holder 60 such that one of the blades 78 is higher than the other blade 78. The blade 78 that is located higher on the tool holder 60 can be exposed above the depth control ring 42. During operation of the rotatable drum assembly 36, the blade 78 that is exposed can be primarily responsible for cutting the feed material while the other blade 78 can be encircled by the depth control ring 42 and effectively protected from the feed material. When the blade 78 that is exposed wears out or is otherwise rendered ineffective for cutting, the tool 62 can be removed, turned upside down and then reattached to the tool holder 60 in the upside down orientation to expose the other blade 78 above the depth control ring 42. It is to be appreciated, that although a pair of blades are shown and described, any of a variety of suitable alternative material engaging features for the tool 62 for land surface preparation and clearing are contemplated, such as for example, one or more of a cutter, blade, grinder, chipper, tooth, knife, hammer tool, milling tool, flailing tool or element, carbide tip, steel tip, or composite tip. It is also to be appreciated that the tool holder 60 and/or the tool 62 can be fabricated from a variety of metals, composites, plastics, or combinations thereof.

Referring again to FIGS. 4 and 5, the main body 66 of the tool holder 60 can define a passageway 82 and the main body 76 of the tool 62 can define a passageway 84. When the tool 62 is attached to the tool holder 60, the passageways 82, 84 can be substantially aligned to accommodate a fastener 86 that secures the tool holder 60 and the tool 62 together. In one embodiment, the passageway 82 can be threaded to allow the fastener 86 to be threadedly coupled with the tool holder 60. In another embodiment, a nut (not shown) can be threaded onto the fastener 86 to facilitate securement of the tool holder 60 and the tool 62 together.

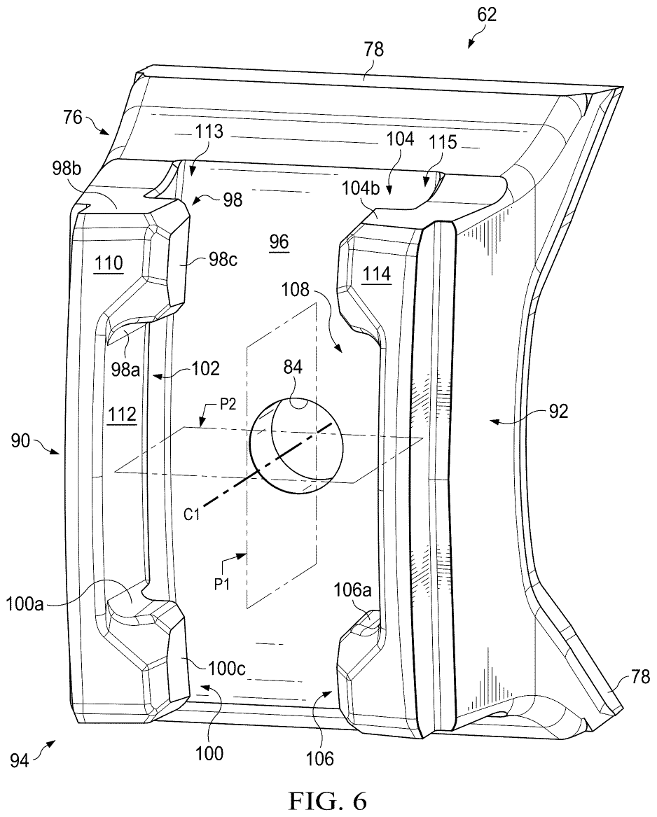

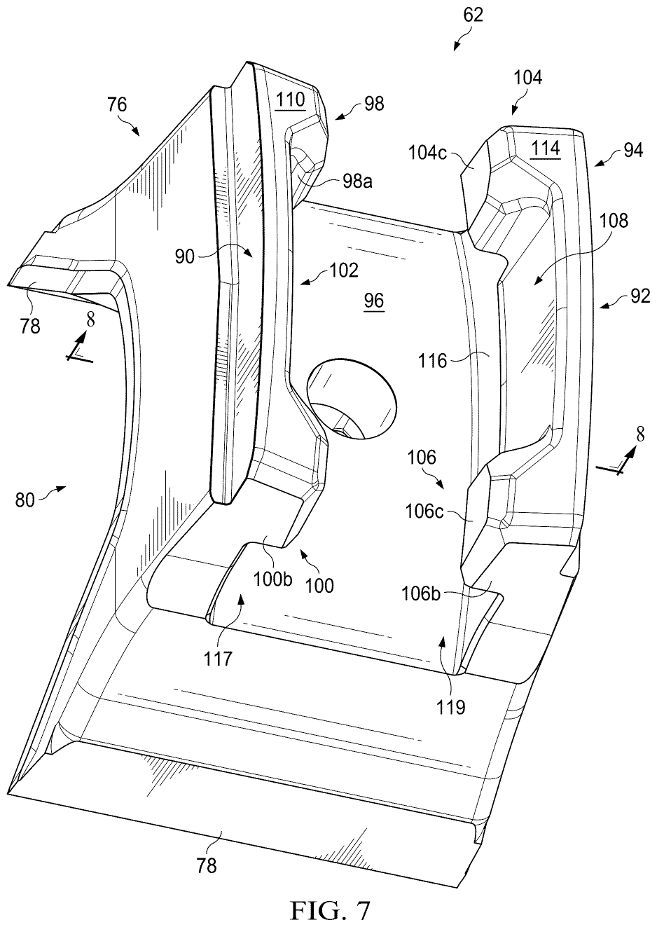

Referring now to FIGS. 6 and 7, the tool 62 can include a first sidewall 90 and a second sidewall 92 that each extend from the main body 76 at a rear end 94 of the tool 62. The first and second sidewalls 90, 92 can be spaced from each other and the main body 76 can include a support surface 96 that extends between the first and second sidewalls 90, 92. A pair of cleats 98, 100 can extend from the first sidewall 90 towards the second sidewall 92 such that the cleats 98, 100 extend laterally inwardly from the first sidewall 90. The cleats 98, 100 can be spaced from each other and the second sidewall 92. The cleats 98, 100 can cooperate with the first sidewall 90 to define a gate 102 therebetween. A pair of cleats 104, 106 can extend from the second sidewall 92 towards the first sidewall 90 such that the cleats 104, 106 extend laterally inwardly from the second sidewall 92. The cleats 104, 106 can be spaced from each other and the first sidewall 90. The cleats 104, 106 can cooperate with the second sidewall 92 to define a gate 108 therebetween. The cleats 98, 100 can be spaced from the cleats 104, 106. As will be described in further detail below, the cleats 98, 100, 104, 106 can interface with the tool interface pillar 72 of the tool holder 60 to retain the tool 62 on to the tool holder 60

Referring again to FIGS. 6 and 7, the cleat 98 can include an interior stop surface 98a, an exterior stop surface 98b, and a face surface 98c that is disposed at a distal end of the cleat 98. The interior stop surface 98a and the exterior stop surface 98b can be disposed on opposite sides of the cleat 98 and can extend between the first sidewall 90 and the face surface 98c. The cleat 100 can include an interior stop surface 100a, an exterior stop surface 100b (FIG. 7), and a face surface 100c that is disposed at a distal end of the cleat 100. The interior stop surface 100a and the exterior stop surface 100b can be disposed on opposite sides of the cleat 100 and can extend between the first sidewall 90 and the face surface 100c. A rear surface 110 can be disposed at a distal end of the first sidewall 90 and can extend along the cleats 98, 100. The first sidewall 90 can include an interior surface 112 that extends to the support surface 96 adjacent the cleats 98, 100.

The cleat 104 can include an interior stop surface 104a (FIG. 7), an exterior stop surface 104b, and a face surface 104c that is disposed at a distal end of the cleat 104. The interior stop surface 104a and the exterior stop surface 104b can be disposed on opposite sides of the cleat 104 and can extend between the second sidewall 92 and the face surface 104c. The cleat 106 can include an interior stop surface 106a, an exterior stop surface 106b (FIG. 7), and a face surface 106c that is disposed at a distal end of the cleat 106. The interior stop surface 106a and the exterior stop surface 106b can be disposed on opposite sides of the cleat 106 and can extend between the second sidewall 92 and the face surface 106c. A rear surface 114 can be disposed at a distal end of the second sidewall 92 and can extend along the cleats 104, 106. The second sidewall 92 can include an interior surface 116 that extends to the support surface 96 adjacent the cleats 104, 106.

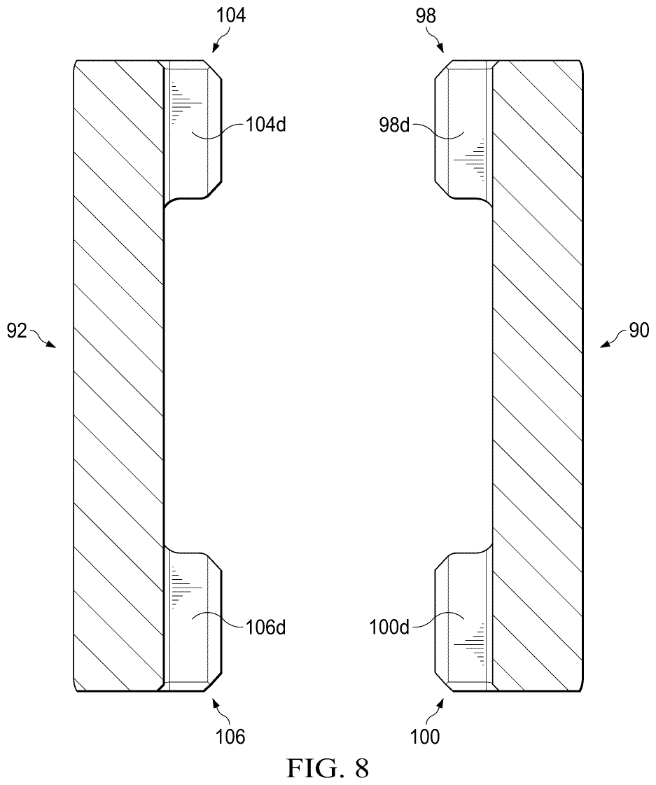

As illustrated in FIG. 8, the cleats 98, 100, 104, 106 can include interface surfaces 98d, 100d, 104d, 106d, respectively. The interface surface 98d of the cleat 98 can extend between the interior stop surface 98a, the exterior stop surface 98b, the face surface 98c and the interior surface 112 of the first sidewall 90. The interface surface 100d of the cleat 100 can extend between the interior stop surface 100a, the exterior stop surface 100b, the face surface 100c and the interior surface 112 of the first sidewall 90. The interface surface 104d of the cleat 104 can extend between the interior stop surface 104a, the exterior stop surface 104b, the face surface 104c and the interior surface 116 of the second sidewall 92. The interface surface 106d of the cleat 106 can extend between the interior stop surface 106a, the exterior stop surface 106b, the face surface 106c and the interior surface 116 of the second sidewall 92.

Referring again to FIGS. 6 and 7, the cleats 98, 104 can be disposed at one end of the tool 62 (e.g., shown as an upper end) and the cleats 100, 106 can be disposed at an opposite end of the tool 62 (e.g., shown as a lower end). Referring now to FIG. 6, the interface surfaces 98d, 104d (FIG. 8) of the cleats 98, 104 can be adjacent to the main body 76, and spaced therefrom, such that a portion of the first sidewall 90 extends between the cleat 98 and the main body 76 and a portion of the second sidewall 92 extends between the cleat 104 and the main body 76. The interface surface 98d, the first sidewall 90 and the main body 76 can cooperate to define a receptacle 113 therebetween and the interface surface 104d, the second sidewall 92 and the main body 76 can cooperate to define a receptacle 115 therebetween. Each of the receptacles 113, 115 can cooperate to provide an elongated slot between the cleats 98, 104 and the main body 76 that extends through the upper end of the tool 62 and permits installation of the upper end onto the tool holder 60.

Referring now to FIG. 7, the interface surfaces 100d, 106d (FIG. 8) of the cleats 100, 106 can be adjacent to the main body 76, and spaced therefrom, such that a portion of the first sidewall 90 extends between the cleat 100 and the main body 76 and a portion of the second sidewall 92 extends between the cleat 106 and the main body 76. The interface surface 100d, the first sidewall 90 and the main body 76 can cooperate to define a receptacle 117 therebetween and the interface surface 106d, the second sidewall 92 and the main body 76 can cooperate to define a receptacle 119 therebetween. Each of the receptacles 117, 119 can cooperate to provide an elongated slot between the cleats 100, 106 and the main body 76 that extends through the lower end of the tool 62 and permits installation of the lower end onto the tool holder 60.

Referring again to FIG. 6, the passageway 82 can define a centerline C1. The rear end 94 of the tool 62 can be vertically and horizontally symmetrical about the centerline C1 to allow the tool 62 to be installed on the tool holder 60 in two different orientations (e.g., selectively inverted) on the same tool holder (e.g., 60). For example, the centerline C1 can reside in an imaginary vertical plane P1 and an imaginary horizontal plane P2. The imaginary vertical plane P1 and the imaginary horizontal plane P2 can be perpendicular to each other such that the centerline C1 resides in both of the imaginary vertical plane P1 and the imaginary horizontal plane P2 (e.g., at the intersection therebetween). The imaginary vertical plane P1 can vertically bisect the tool 62 and the imaginary horizontal plane P2 can horizontally bisect the tool 62. The rear end 94 of the tool 62 can be vertically symmetrical about the imaginary vertical plane P1 such that the arrangement and structure of the cleats 98, 100 and the cleats 104, 106 are effectively mirror images of each other. The rear end 94 of the tool 62 can be horizontally symmetrical about the imaginary horizontal plane P2 such that the arrangement and structure of the cleats 98, 104 and the cleats 100, 106 are effectively mirror images of each other. It is to be appreciated that although each of the cleats 98, 100, 104, 106 are shown to be similarly shaped, in some embodiments, one of the pairs of diagonally opposite cleats (e.g., cleats 98, 106) can be the same shape and the other pair of diagonally opposite cleats (e.g., cleats 100, 104) can be the same shape, but the shapes of the respective diagonal pairs can be different. For example, cleats 98, 106 might be cylinder shaped, and cleats 100, 104 might be triangular shaped. In any event, in such embodiments, the tool 62 can still be capable of being installed in two different orientations even though the respective shapes of the diagonal pairs are different.

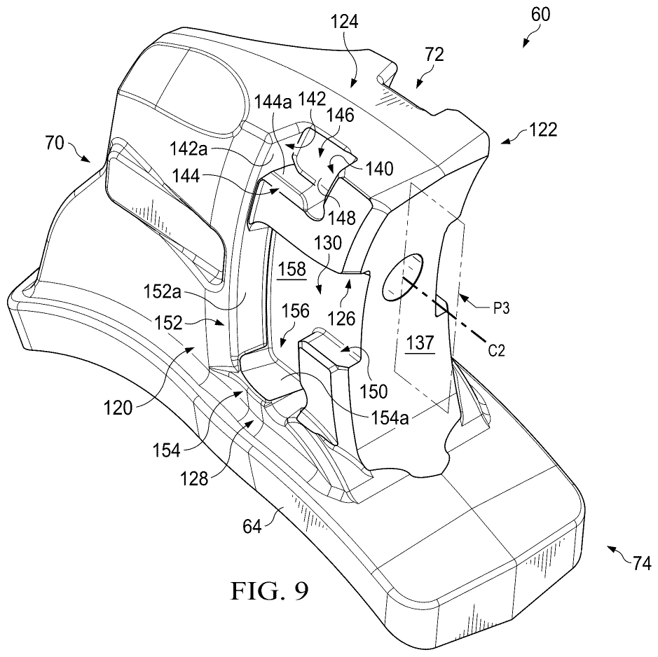

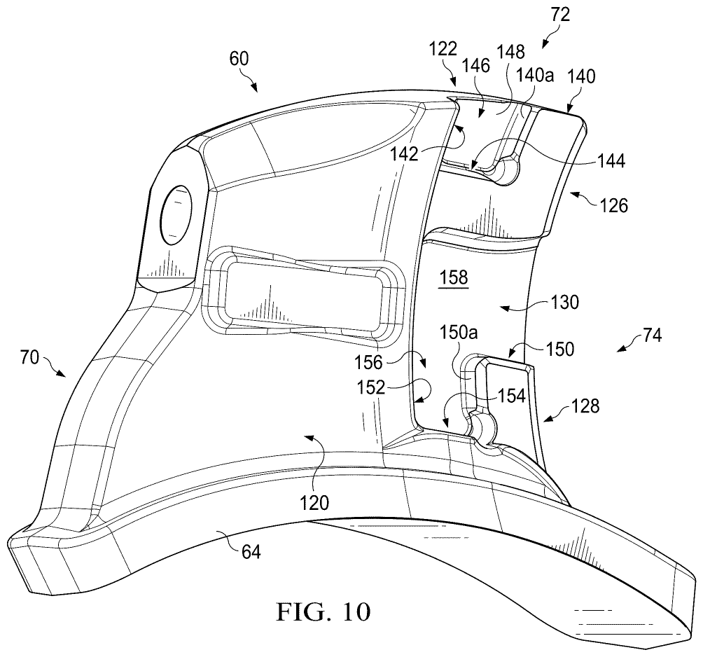

Referring now to FIGS. 9-12, the tool interface pillar 72 can include a left side 120 (FIG. 9), a right side 122 (FIG. 10) and a main portion 124 that at least partially defines the passageway 82. As illustrated in FIG. 9, the passageway 82 can define a centerline C2. The centerline C2 can reside in an imaginary vertical plane P3 that extends along the main portion and bisects the tool interface pillar 72 into the left and right sides 120, 122. In order for the tool interface pillar 72 to accommodate attachment of the tool 62 in either orientation described above, the left and right sides 120, 122 can be symmetrical about the imaginary vertical plane P3 such that they are substantial mirror images of each other.

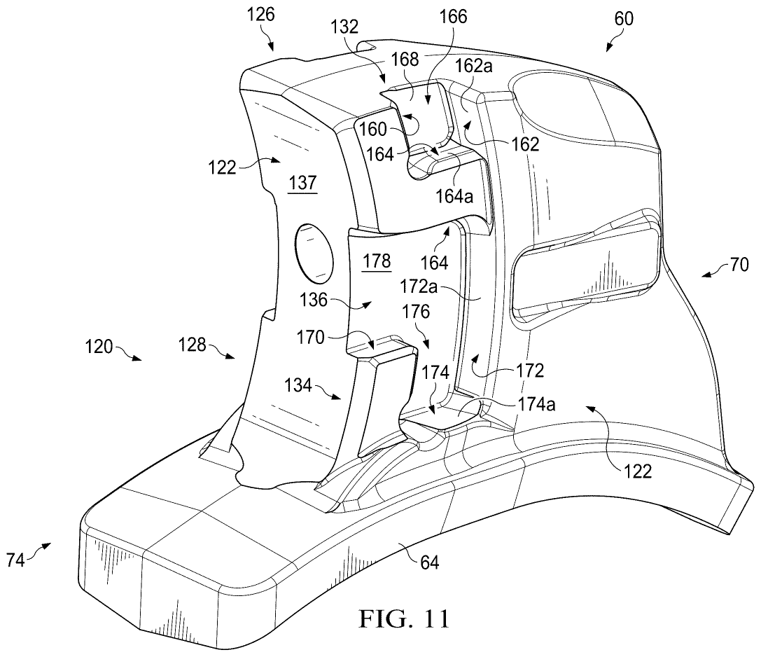

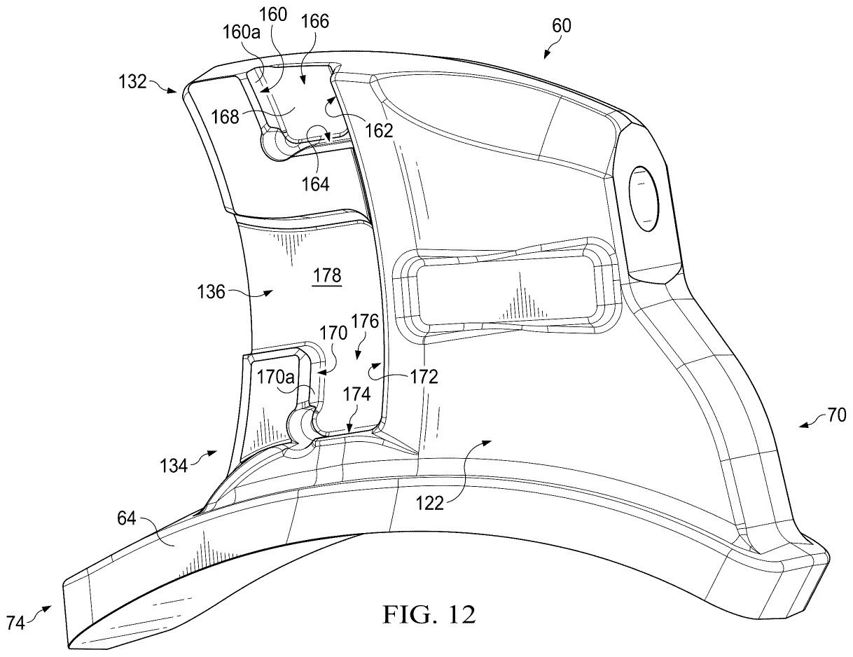

As illustrated in FIGS. 9 and 10, the tool interface pillar 72 can include a left upper cleat support structure 126 and a left lower cleat support structure 128 that each extend laterally outwardly from the main portion 124 on the left side 120 of the tool interface pillar 72. The left upper and left lower cleat support structures 126, 128 can be vertically spaced from each other and can cooperate with the main portion 124 to define a left gate 130. As illustrated in FIGS. 11 and 12, the tool interface pillar 72 can include a right upper cleat support structure 132 and a right lower cleat support structure 134 that extend laterally outwardly from the main portion 124 on the right side 122 of the tool interface pillar 72. The right upper and right lower cleat support structures 132, 134 can be vertically spaced from each other and can cooperate with the main portion 124 to define a right gate 136. The main portion 124 can include a support surface 137 that is disposed at a front end 74 of the tool holder 60. As will be described in further detail below, the cleat support structures 126, 128, 132, 134 can cooperate with the cleats 98, 100, 104, 106 to facilitate attachment of the tool 62 to the tool holder 60.

Referring again to FIGS. 9 and 10, the left upper cleat support structure 126 can include a left cleat support 140, a rear support portion 142, and a lower support portion 144. The left cleat support 140 can be disposed at a front of the tool holder 60 and positioned in front of the rear support portion 142 and spaced therefrom such that the lower support portion 144 can extend therebetween. The left cleat support 140 and the rear and lower support portions 142, 144 can cooperate with the main portion 124 to define a slot 146 for receiving one of the cleats 100, 104. As illustrated in FIG. 9, the rear support portion 142 can include a rear surface 142a and the lower support 144 can include a lower surface 144a. As illustrated in FIG. 10, the left cleat support 140 can include an interface surface 140a that extends upwardly from the lower surface 144a in front of the rear and lower surfaces 142a, 144a. The interface surface 140a can be adjacent to the rear surface 144a, and spaced therefrom, and the lower surface 144a can extend between the interface and rear surfaces 140a, 142a. The main portion 124 can include a face surface 148 that extends between the interface, rear, and lower surfaces 140a, 142a, 144a.

The left lower cleat support structure 128 can include a left cleat support 150, a rear support portion 152, and a lower support portion 154. The left cleat support 150 can be positioned disposed at a front of the tool holder 60 and in front of the rear support portion 152 and spaced therefrom such that the lower support portion 154 can extend therebetween. The left cleat support 150 and the rear and lower support portions 152, 154 can cooperate with the main portion 124 to define a slot 156 for receiving one of the cleats 98, 106. As illustrated in FIG. 9, the rear support portion 152 can include a rear surface 152a and the lower support surface 154 can include a lower surface 154a. As illustrated in FIG. 10, the left cleat support 150 can include an interface surface 150a that extends upwardly from the lower surface 154a in front of the rear and lower surfaces 152a, 154a. The interface surface 150a can be adjacent to the rear surface 154a, and spaced therefrom, and the lower surface 154a can extend between the interface and rear surfaces 150a, 152a. The main portion 124 can include a face surface 158 that extends between the interface, rear, and lower surfaces 150a, 152a, 154a. It is to be appreciated that the rear support portions 142, 152 are shown to be an integral part of the rear support portion 152 such that any reference to the rear support portions 142, 152 or the rear surfaces 142a, 152a can also be understood to generally refer to the rear portion 68.

The right upper and right lower cleat support structures 132, 134 can be similar to the left upper and lower cleat support structures 126, 128 except that they are provided on the right side 122 of the tool interface pillar 72. Referring again to FIGS. 11 and 12, the right upper cleat support structure 132 can include a right cleat support 160, a rear support portion 162, and a lower support portion 164. The right cleat support 160 can be disposed at a front of the tool holder 60 and positioned in front of the rear support portion 162 and spaced therefrom such that the lower support portion 164 can extend therebetween. The right cleat support 160 and the rear and lower support portions 162, 164 can cooperate with the main portion 124 to define a slot 166 for receiving one of the cleats 98, 106. As illustrated in FIG. 11, the rear support portion 162 can include a rear surface 162a and the lower support 164 can include a lower surface 164a. As illustrated in FIG. 10, the right cleat support 160 can include an interface surface 160a that extends upwardly from the lower surface 164a in front of the rear and lower surfaces 162a, 164a. The interface surface 160a can be adjacent to the rear surface 164a, and spaced therefrom, and the lower surface 164a can extend between the interface and rear surfaces 160a, 162a. The main portion 124 can include a face surface 168 that extends between the interface, rear, and lower surfaces 160a, 162a, 164a.

The right lower cleat support structure 134 can include a right cleat support 170, a rear support portion 172, and a lower support portion 174. The right cleat support 170 can be disposed at a front of the tool holder 60 and positioned in front of the rear support portion 172 and spaced therefrom such that the lower support portion 174 can extend therebetween. The right cleat support 170 and the rear and lower support portions 172, 174 can cooperate with the main portion 124 to define a slot 176 for receiving one of the cleats 100, 104. As illustrated in FIG. 11, the rear support portion 172 can include a rear surface 172a and the lower support surface 174 can include a lower surface 174a. As illustrated in FIG. 12, the right cleat support 170 can include an interface surface 170a that extends upwardly from the lower surface 174a in front of the rear and lower surfaces 172a, 174a. The interface surface 170a can be adjacent to the rear surface 174a, and spaced therefrom, and the lower surface 174a can extend between the interface and rear surfaces 170a, 172a. The main portion 124 can include a face surface 178 that extends between the interface, rear, and lower surfaces 170a, 172a, 174a. It is to be appreciated that the rear support portions 162, 172 are shown to be an integral part of the rear portion 68 such that any reference to the rear support portions 162, 172 or the rear surfaces 162a, 172a can also be understood to generally refer to the rear portion 68.

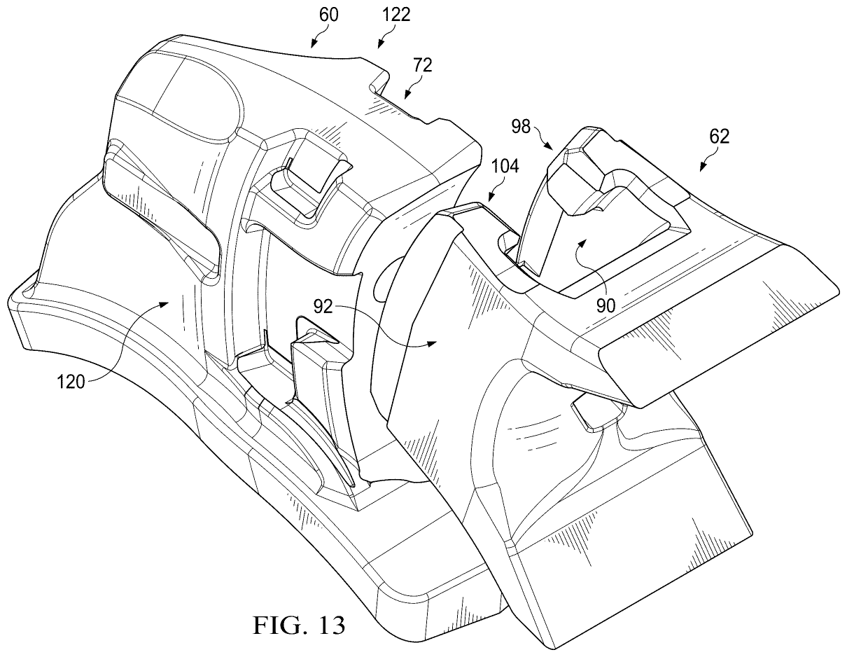

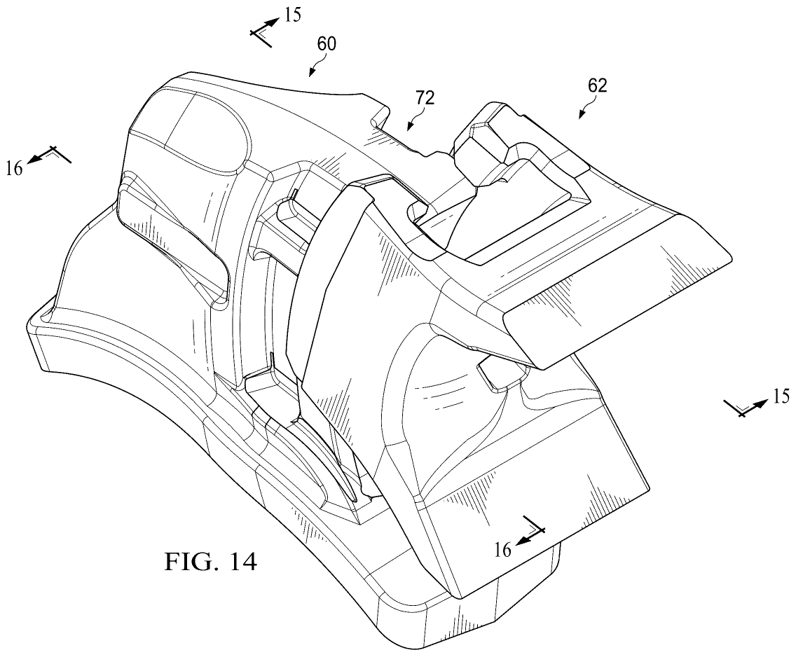

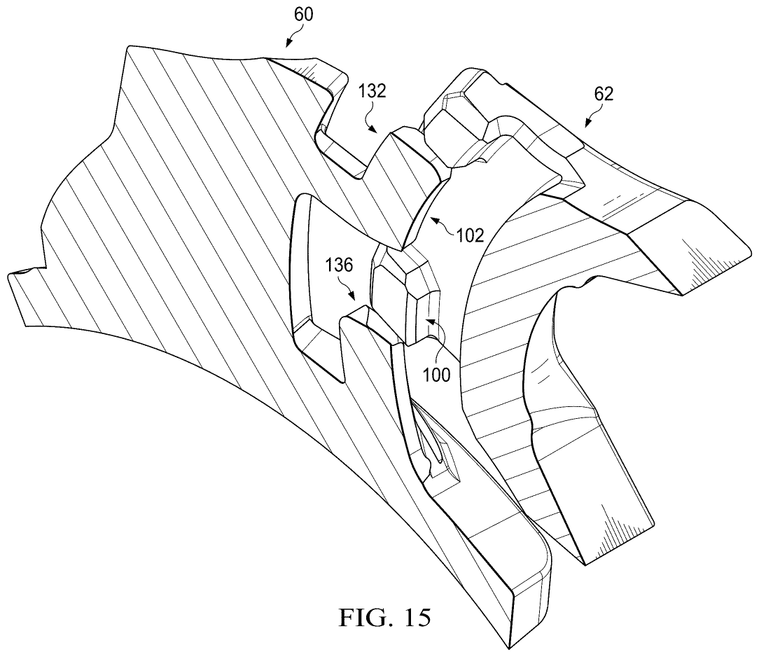

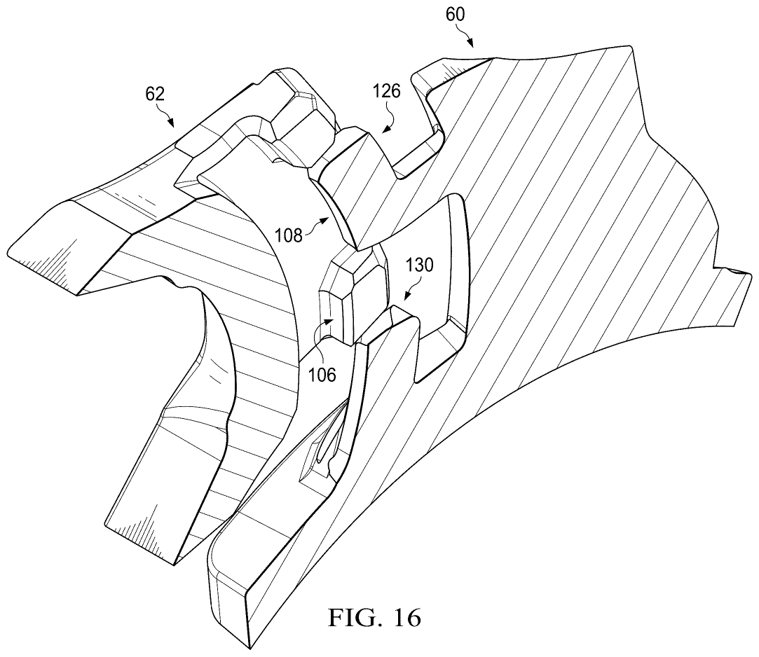

Referring now to FIGS. 13-16, the installation of the tool 62 onto the tool holder 60 is illustrated and will now be described. First, as illustrated in FIG. 13, the tool 62 can be oriented with the cleats 98, 104 above the cleats 100, 106 such that the first and second sidewalls 90, 92 are disposed on the right and left sides 122, 120, respectively, of the tool interface pillar 72 with the receptacles 117, 119 facing the right lower cleat support structure 134 and the left lower cleat support structure 128, respectively. Next, as illustrated in FIGS. 14-16, the tool 62 can be initially fit onto the front of the tool interface pillar 72. As illustrated in FIG. 15, the right upper cleat support structure 132 can be at least partially disposed in the gate 102 of the tool 62 and the cleat 100 can be at least partially disposed in the right gate 136 (FIG. 11) and above the lower cleat support structure 134 of the tool holder 60. As illustrated in FIG. 16, the left upper cleat support structure 126 can be at least partially disposed in the gate 108 of the tool 62 and the cleat 106 can be at least partially disposed in the left gate 130 (FIG. 9) and above the left lower cleat support structure 128 of the tool holder 60. The gates 102, 108 of the tool 62 and the right and left gates 136, 130 of the tool holder 60 can allow for passage of the upper cleat support structures 132, 126 and the cleats 100, 106, respectively to encourage proper alignment of the tool 62 onto the tool holder 60. As the tool 62 is being aligned on the tool holder 60, the face surfaces 100c, 106c of the cleats 100, 106 can ride along the face surfaces 178, 158 of the main portion 124, the front and lower support portions 150, 154 of the lower cleat support structure 128 can ride along the interior surface 116 of the second sidewall 92, and the right cleat support 170 and the lower support portion 174 of the right lower cleat support structure 134 can ride along the interior surface 112 of the first sidewall 90 to further encourage proper alignment of the tool 62 onto the tool holder 60.

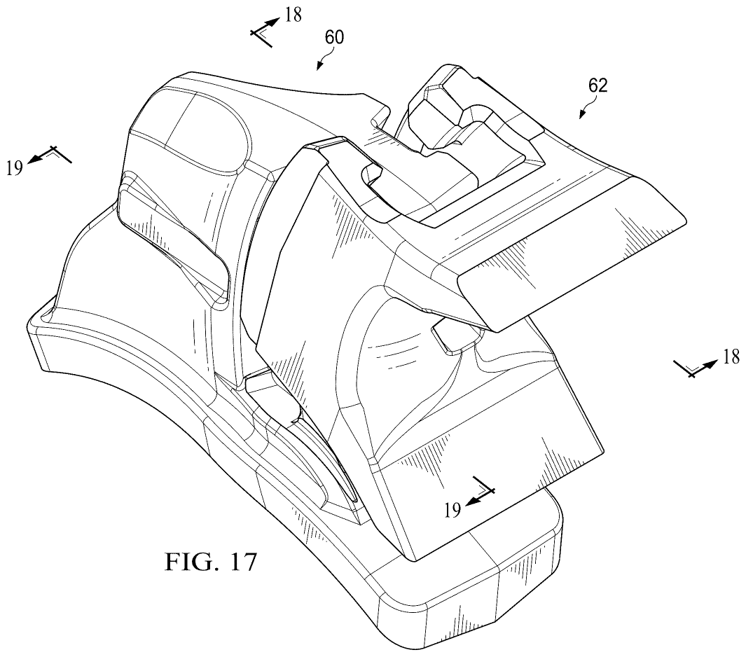

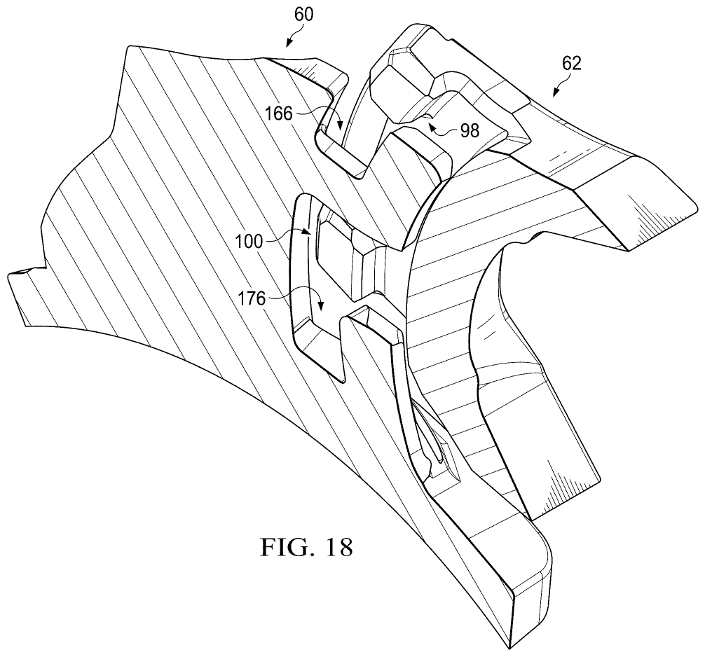

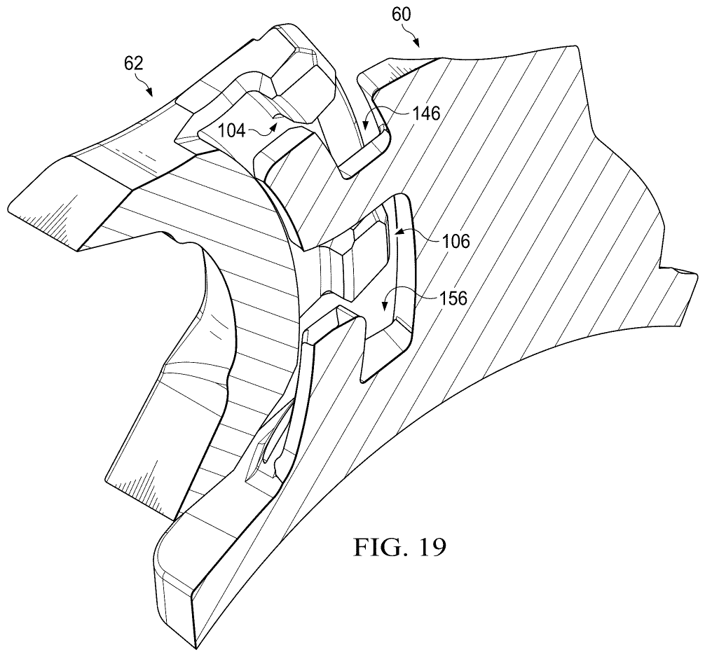

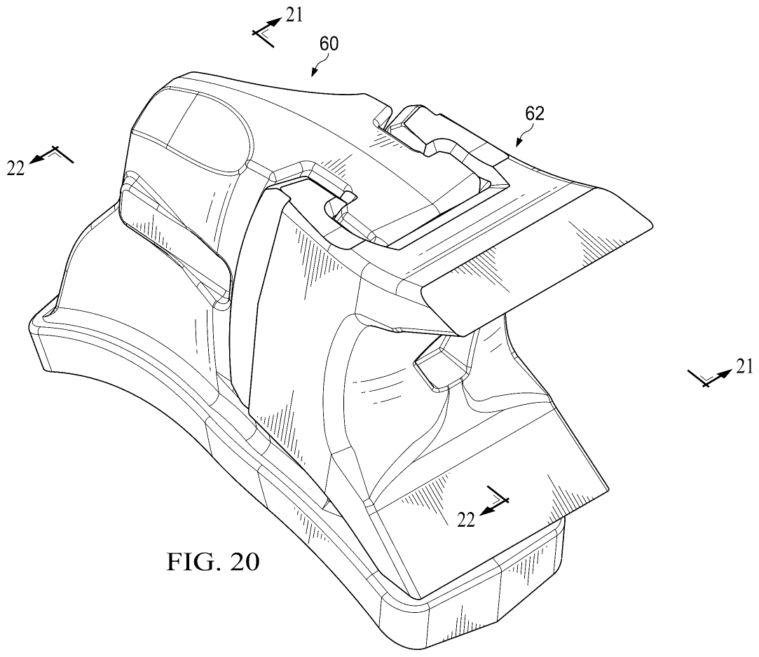

Next, as illustrated in FIGS. 17-19, the tool 62 can be pushed further onto the tool interface pillar 72 until the support surfaces 96, 137 interface with each other. As illustrated in FIGS. 18 and 19, in this position, the receptacles 117, 119 can be aligned with the right cleat support 170 and the left cleat support 150, respectively, the cleats 98, 100 can be disposed above the slots 166, 176 respectively, and the cleats 104, 106 can be disposed above the slots 146, 156, respectively. Next, as illustrated in FIGS. 20-22, the tool 62 can be slid downwardly to insert the right cleat support 170 and the left cleat support 150 into the receptacles 117, 119, respectively, until the cleats 98, 100 are nested into the upper and lower cleat support structures 132, 134 and the cleats 104, 106 are nested into the upper and lower cleat support structures 126, 128 such that the tool 62 is fully interlocked with the tool interface pillar 72. With the tool 62 interlocked on the tool holder 60, the interface, rear and interior stop surfaces 104d, 114, 104a of the cleat 104 can be immediately adjacent, and in some embodiments can contact, the interface, rear, and lower surfaces 140a, 142a, 144a, respectively, of the left upper cleat support structure 126. The face surface 104c of the cleat 104 can be immediately adjacent, and in some embodiments can contact, the face surface 148 of the main portion 124. The interface, rear and exterior stop surfaces 106d, 114, 106b of the cleat 106 can be immediately adjacent, and in some embodiments can contact, the interface, rear, and lower surfaces 150a, 152a, 154a, respectively, of the left lower cleat support structure 128. The face surface 106c of the cleat 106 can be immediately adjacent, and in some embodiments can contact, the face surface 158 of the main portion 124. The interface, rear and interior stop surfaces 98d, 110, 98a of the cleat 98 can be immediately adjacent, and in some embodiments can contact, the interface, rear, and lower surfaces 160a, 162a, 164a, respectively, of the right upper cleat support structure 132. The face surface 98c of the cleat 98 can be immediately adjacent, and in some embodiments can contact, the face surface 168 of the main portion 124. The interface, rear and exterior stop surfaces 100d, 110, 100b of the cleat 100 can be immediately adjacent, and in some embodiments can contact, the front, rear, and lower surfaces 170a, 172a, 174a, respectively, of the lower cleat support structure 134. The face surface 100c of the cleat 100 can be immediately adjacent, and in some embodiments can contact, the face surface 178 of the main portion 124. Once the tool 62 is interlocked with the tool interface pillar 72, the fastener 86 can be installed though the passageways 82, 84, to facilitate further securement of the tool 62 to the tool holder 60 thereby completing the installation of the tool 62 on the tool holder 60.

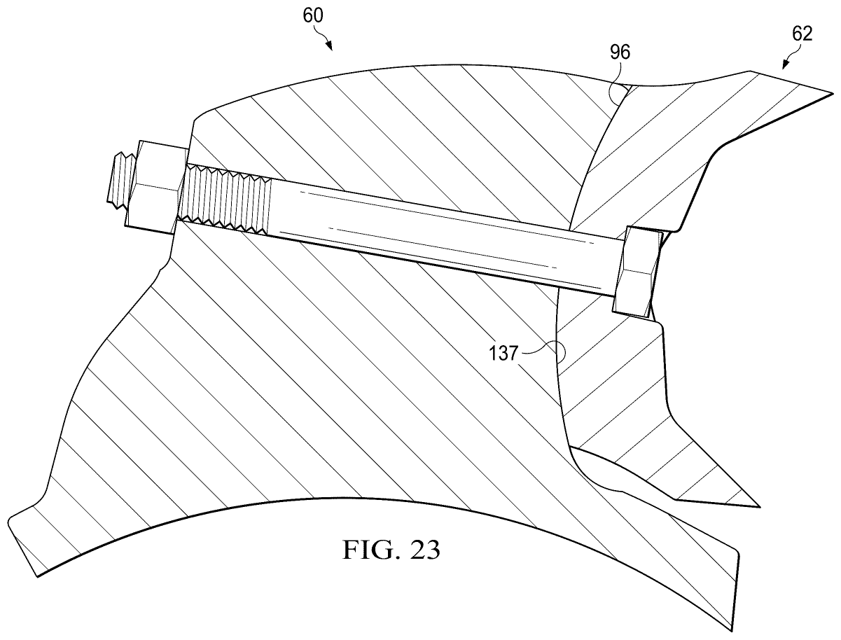

Referring now to FIG. 23 each of the support surfaces 96, 137 of the tool 62 and the tool holder 60 can be substantially arcuate shaped between the upper and lower ends (when viewed perpendicularly to the imaginary vertical planes P1 and P3). The rear surfaces 110, 114 of the tool 62 and the rear surfaces 142a, 152a, 162a, 172a of the tool holder 60 can also be substantially arcuate shaped. The arcuate shaped surfaces can be complementary to each other and can have a substantially similar radius of curvature. As such, the tool 62 can rotate slightly when seating the cleats 98, 100, 104, 106 in the upper and lower cleat support structures 126, 128, 132, 134. In one, embodiment, the radius of curvature of the tool 62 and the tool holder 60 can be between about two inches and about six inches.

During operation of the rotatable drum assembly 36, the arcuate shape of the support surfaces 96, 137 can distribute the resultant force that is imparted to the tool 62 from the feed material more evenly to the tool holder 60 than conventional tool assembly arrangements. In addition, the resultant force from feed material can be more evenly distributed among the interface between the rear and interior stop surfaces 114, 104a of the cleat 104 and the rear and lower surfaces 142a, 144a, respectively, of the left upper cleat support structure 126, between the rear and exterior stop surfaces 114, 106b of the cleat 106 and the rear and lower surfaces 152a, 154a, respectively, of the left lower cleat support structure 128, between the rear and interior stop surfaces 110, 98a of the cleat 98 and the rear and lower surfaces 162a, 164a, respectively, of the right upper cleat support structure 132, and between the rear and exterior stop surfaces 110, 100b of the cleat 100 and the rear and lower surfaces 172a, 174a, respectively, of the right lower cleat support structure 134. As such, the tool assembly 40 can be less susceptible to failure and can be stronger than conventional arrangements while using less material which can be more cost effective and less time consuming to manufacture.

It is to be appreciated that removal of the tool 62 from the tool holder 60 can be achieved by reversing the installation steps outlined above. In some embodiments, the tool 62 can be removed from the tool holder 60 and reinstalled on the tool holder 60 in an inverted orientation. In these embodiments, the tool 62 can be provided in the inverted orientation to allow for use of the other blade 78 when the original blade 78 has worn out, become damaged or is otherwise not suitable for cutting. When the tool 62 is installed on the tool holder 60 in the inverted orientation, the tool 62 can be oriented with the cleats 100, 106 above the cleats 98, 104 such that the first and second sidewalls 90, 92 are to be disposed on the left and right sides 120, 122, respectively, of the tool interface pillar 72. The installation of the tool 62 in this orientation can be similar to the installation method described above except that the cleats 98, 100 interface with the left lower and upper cleat support structures 128, 126, respectively, on the left side 120 of the tool interface pillar 72 and the cleats 104, 106 interface with the right lower and upper cleat support structures 134, 132 on the right side 122 of the tool interface pillar 72. For example, when the tool 62 is initially fit onto the front of the tool interface pillar 72, the left upper cleat support structure 126 can be at least partially disposed in the gate 102 of the tool 62, the cleat 100 can be at least partially disposed in the left gate 130 (FIG. 9) of the tool holder 60, the right upper cleat support structure 132 can be at least partially disposed in the gate 108 of the tool 62, and the cleat 106 can be at least partially disposed in the right gate 136 (FIG. 11).

When the tool 62 is interlocked with the tool interface pillar 72, the front, rear and interior stop surfaces 100d, 110, 100a of the cleat 100 can be immediately adjacent, and in some embodiments can contact, the front, rear, and lower surfaces 140a, 142a, 144a, respectively, of the left upper cleat support structure 126. The face surface 100c of the cleat 100 can be immediately adjacent, and in some embodiments can contact, the face surface 148 of the main portion 124. The front, rear and exterior stop surfaces 98d, 110, 98b of the cleat 98 can be immediately adjacent, and in some embodiments can contact, the front, rear, and lower surfaces 150a, 152a, 154a, respectively, of the left lower cleat support structure 128. The face surface 98c of the cleat 98 can be immediately adjacent, and in some embodiments can contact, the face surface 158 of the main portion 124. The front, rear and interior stop surfaces 106d, 114, 106a of the cleat 106 can be immediately adjacent, and in some embodiments can contact, the front, rear, and lower surfaces 160a, 162a, 164a, respectively, of the right upper cleat support structure 132. The face surface 106c of the cleat 106 can be immediately adjacent, and in some embodiments can contact, the face surface 168 of the main portion 124. The front, rear and exterior stop surfaces 104d, 114, 104b of the cleat 104 can be immediately adjacent, and in some embodiments can contact, the front, rear, and lower surfaces 170a, 172a, 174a, respectively, of the right lower cleat support structure 134. The face surface 104c of the cleat 100 can be immediately adjacent, and in some embodiments can contact, the face surface 178 of the main portion 124.

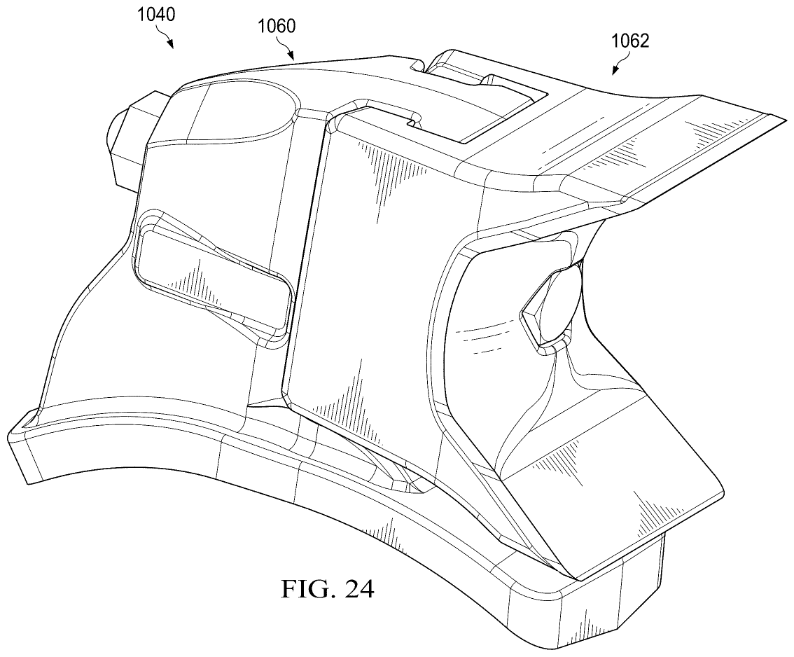

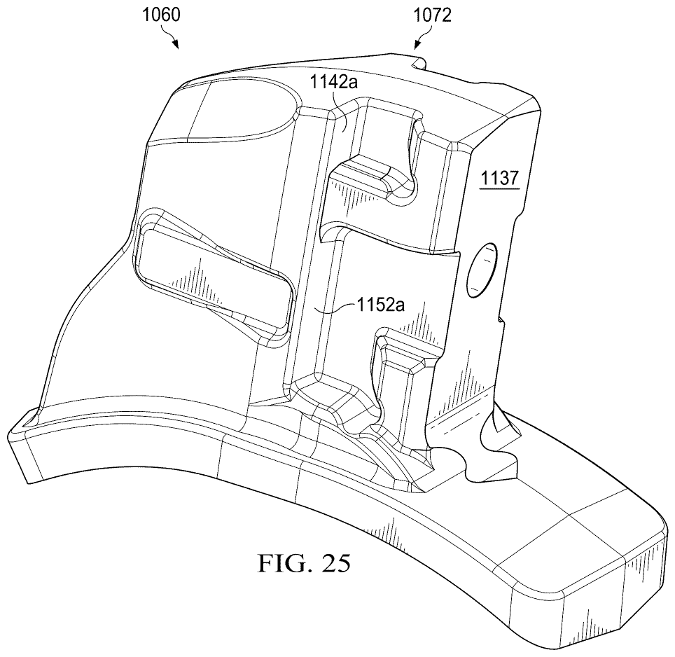

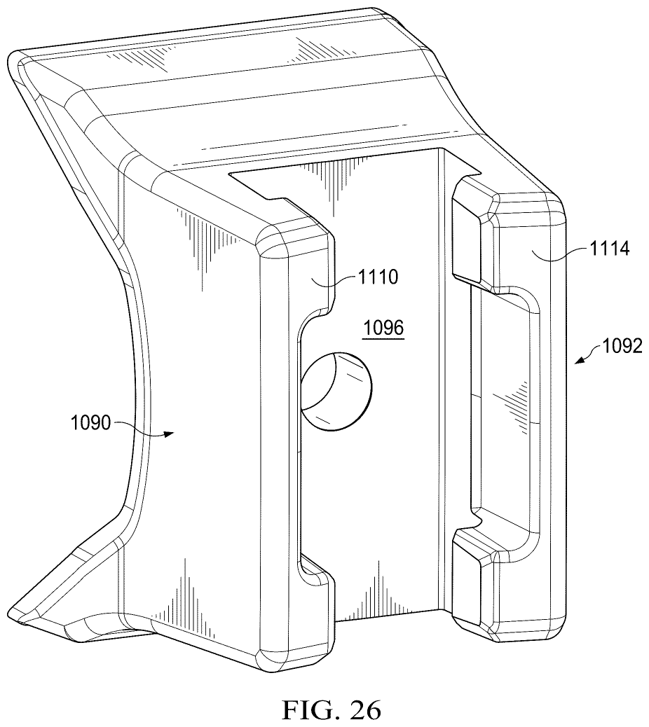

FIGS. 24-26 illustrate an alternative embodiment of a tool assembly 1040 that is similar to, or the same in many respects as the tool assembly 40 illustrated in FIGS. 4-23. For example, as illustrated in FIG. 24, the tool assembly 1040 can include a tool holder 1060 and a tool 1062. As illustrated in FIG. 25, the tool holder 1060 can include a tool interface pillar 1072 that includes a support surface 1137 and a plurality of rear surfaces 1142a, 1152a (two not shown). As illustrated in FIG. 26, the tool 1062 can include a first sidewall 1090, a second sidewall 1092, and a support surface 1096 that extends between the first and second sidewalls 1090, 1092. Rear surfaces 1110, 1114 can be disposed at distal ends of the first and second sidewalls 1090, 1092, respectively. However, the support surfaces 1096, 1137 and the rear surfaces 1110, 1114, 1142a, 1152a can be substantially planar (e.g., non-arcuate).

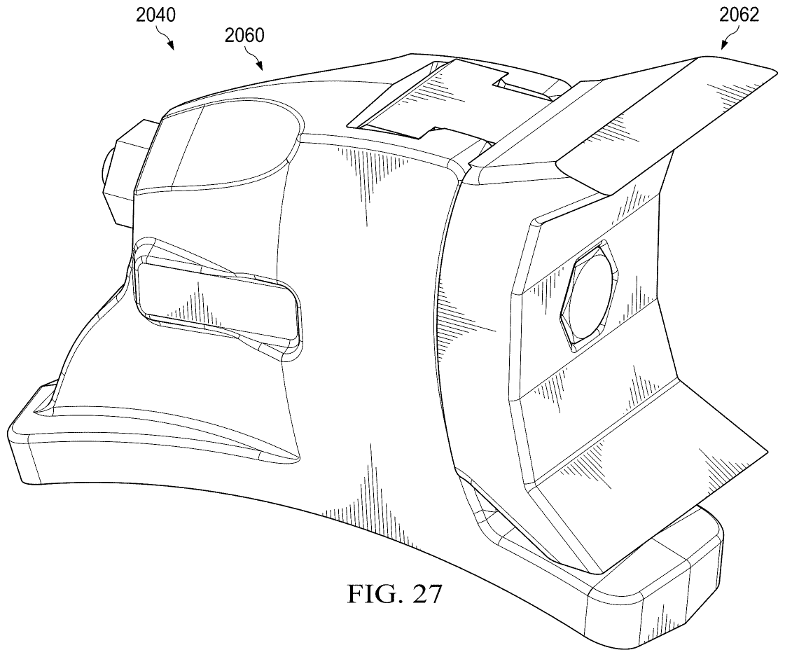

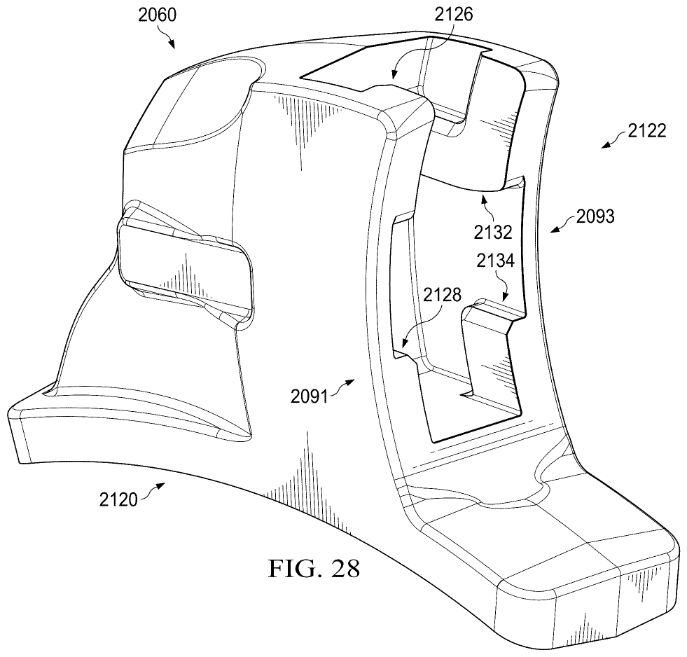

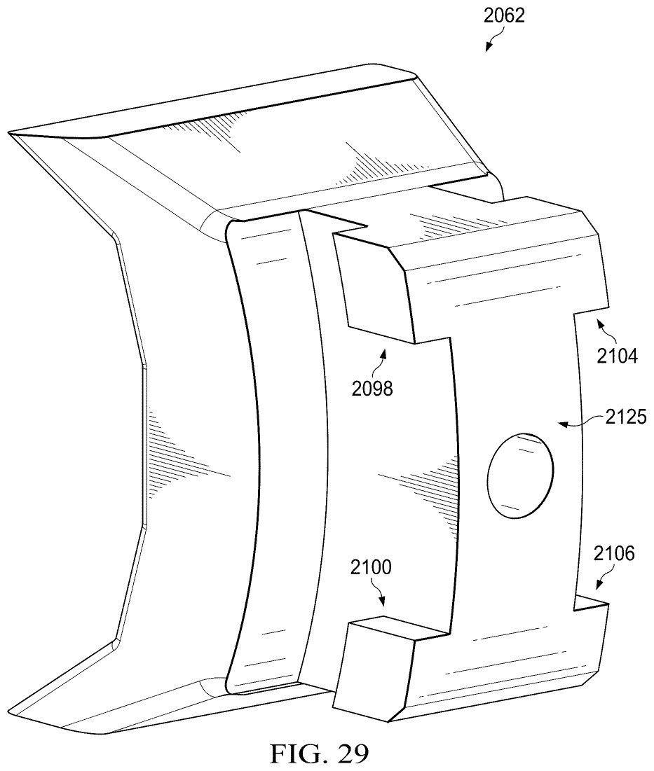

FIGS. 27-29 illustrate an alternative embodiment of a tool assembly 2040 that is similar to, or the same in many respects as the tool assembly 40 illustrated in FIGS. 4-23. For example, as illustrated in FIG. 27, the tool assembly 2040 can include a tool holder 2060 and a tool 2062. As illustrated in FIG. 28, the tool holder 2060 can include upper and lower cleat support structures 2126, 2128 disposed on a left side 2120 and upper and lower cleat support structures 2132, 2134 disposed on a right side 2122. The cleat support structures 2126, 2128, 2132, 2134, however, extend laterally inwardly from opposing sidewalls 2091, 2093. As illustrated in FIG. 29, the tool 2062 can include cleats 2098, 2100, 2104, 2106 that interface with the cleat support structures 2126, 2128, 2132, 2134 to facilitate coupling of the tool 2062 to the tool holder 2060. The cleats 2098, 2100, 2104, 2106, however, extend laterally outwardly from a main portion 2125 of the tool 2062.

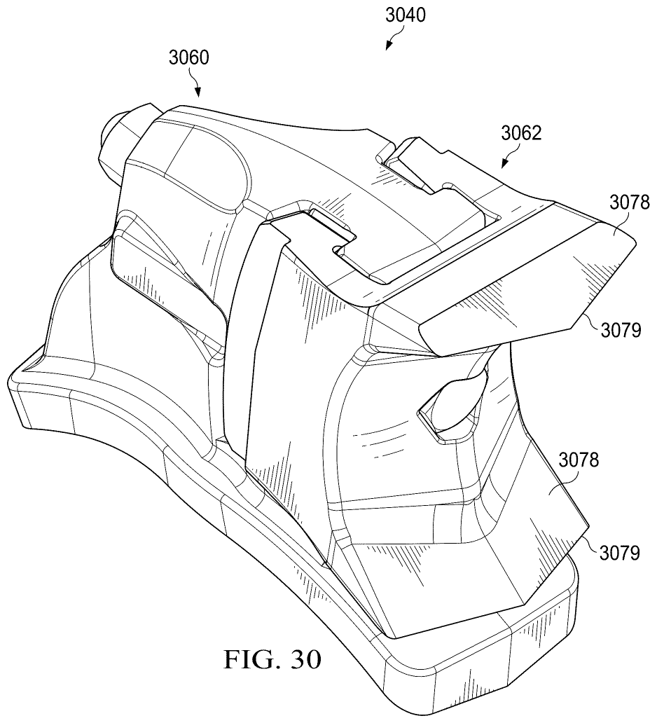

FIG. 30 illustrates another alternative embodiment of a tool assembly 3040 that is similar to, or the same in many respects as the tool assembly 40 illustrated in FIGS. 4-23. For example, the tool assembly 3040 can include a tool holder 3060 and a tool 3062. The tool 3062 can include a pair of blades 3078 that each have a leading edge 3079. The leading edges 3079, however, can be pointed (e.g., in a sword configuration).

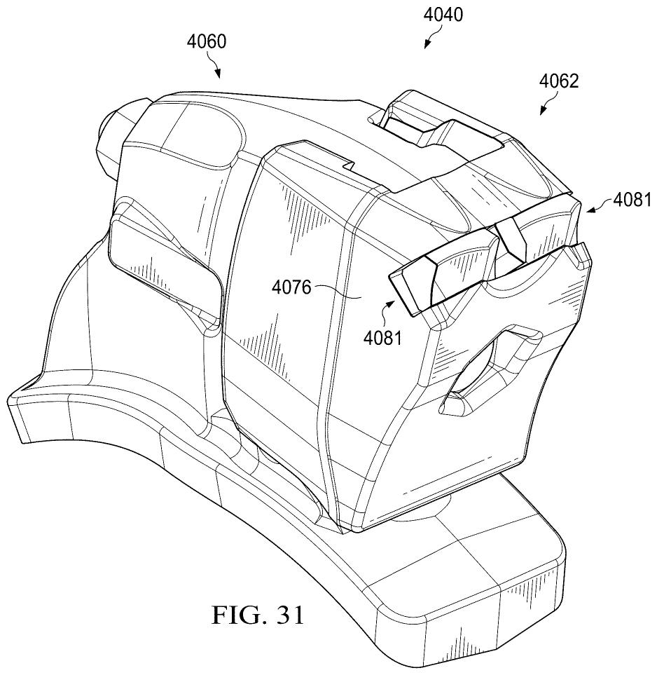

FIG. 31 illustrates yet another alternative embodiment of a tool assembly 4040 that is similar to, or the same in many respects as the tool assembly 40 illustrated in FIGS. 4-23. For example, the tool assembly 4040 can include a tool holder 4060 and a tool 4062. The tool 4062, however, can include a carbide tip 4081 that is attached to a main body 4076.

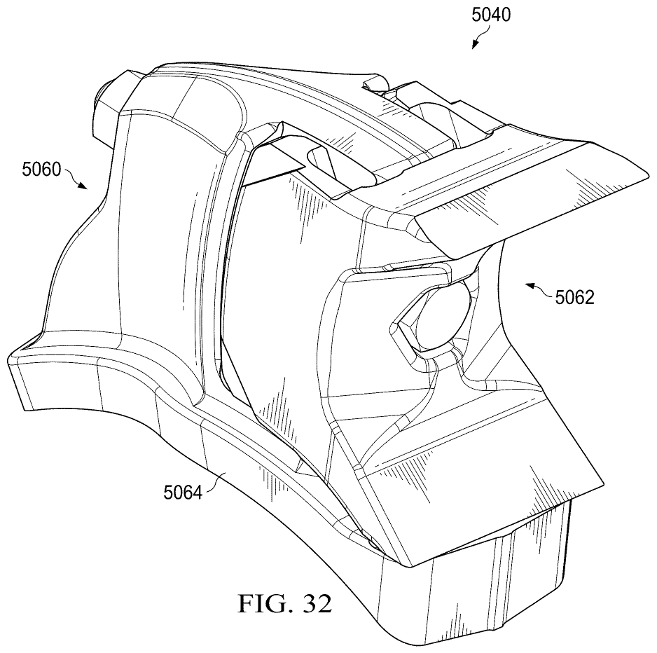

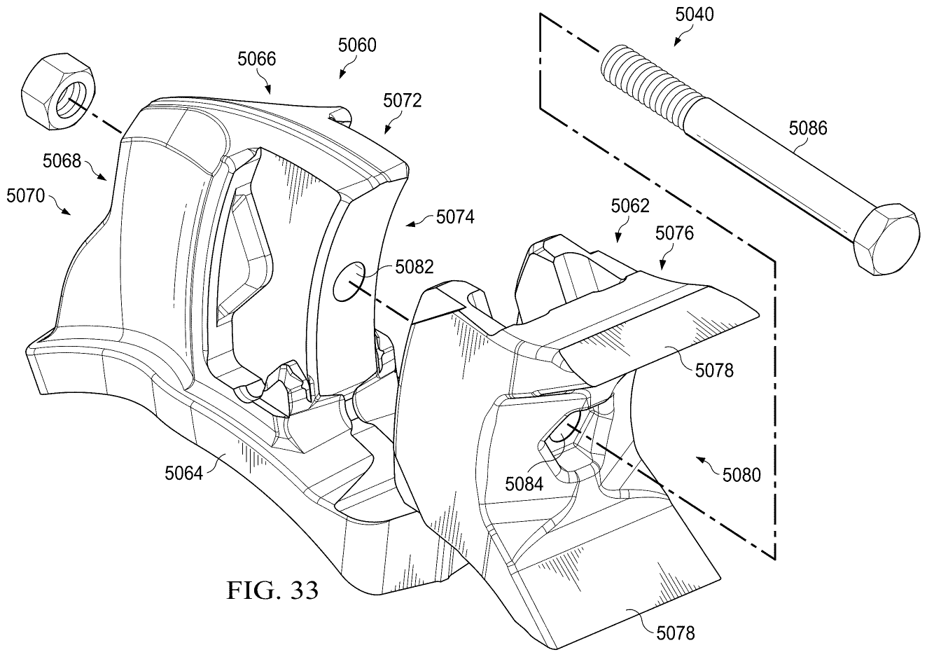

FIGS. 32-42 illustrate an alternative embodiment of a tool assembly 5040 that is similar to, or the same in many respects as the tool assembly 40 illustrated in FIGS. 4-23. For example, as illustrated in FIGS. 32 and 33, the tool assembly 5040 can include a tool holder 5060 and a tool 5062. As illustrated in FIG. 33, the tool holder 5060 can include a base flange 5064 and a main body 5066 that extends upwardly from the base flange 5064. The main body 5066 can include a rear portion 5068 disposed at a rear end 5070 of the tool holder 5060 and a tool interface pillar 5072 disposed at a front end 5074 of the tool holder 5060 and extending from the rear portion 5068. The tool 5062 can include a main body 5076 and a pair of blades 5078 disposed at a front end 5080 of the tool 5062. The main bodies 5066, 5076 can define respective passageways 5082, 5084 for accommodating a fastener 5086.

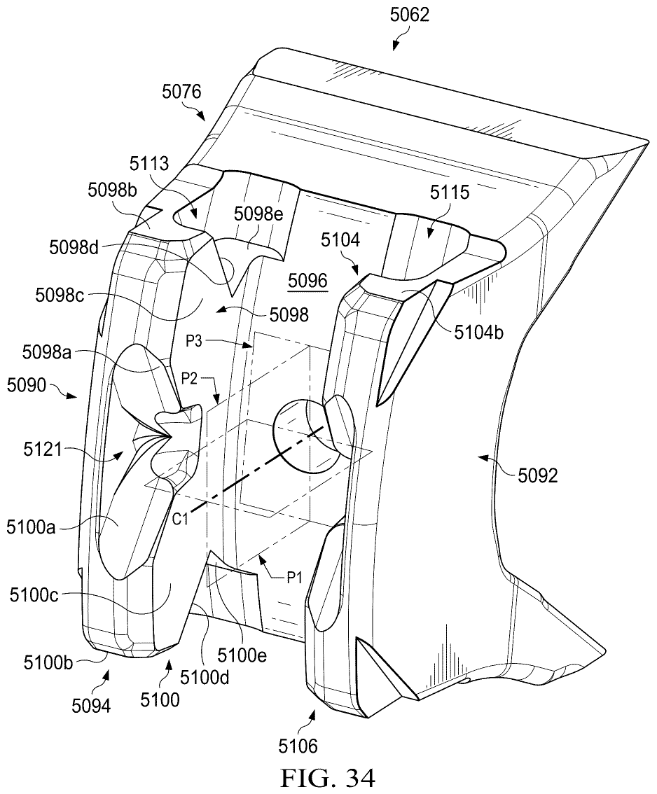

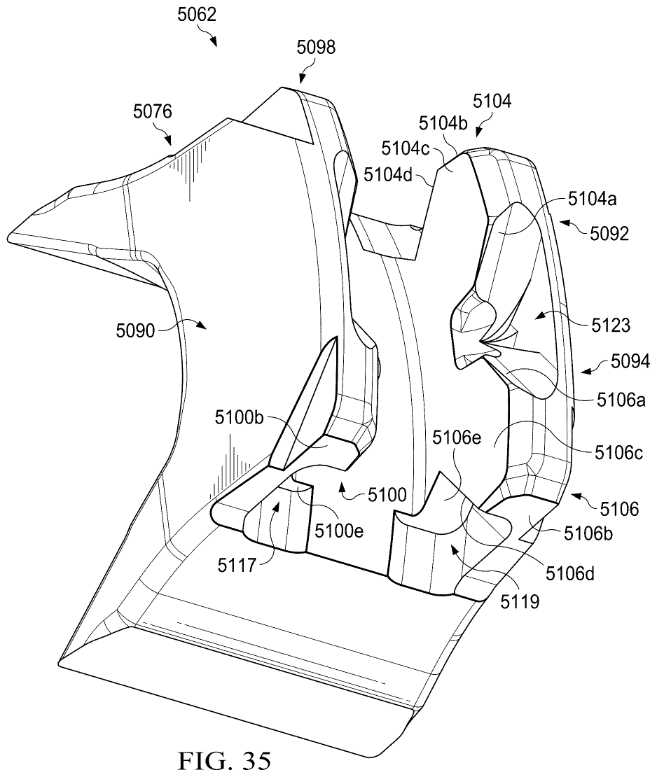

Referring now to FIGS. 34 and 35, the tool 5062 can include a first sidewall 5090 and a second sidewall 5092 that are disposed at a rear end 5094 of the tool 5062. A pair of cleats 5098, 5100 can extend from the first sidewall 5090, and a pair of cleats 5104, 5106 can extend from the second sidewall 5092. The cleats 5098, 5104 can be disposed at one end of the tool 5062 (e.g., shown as an upper end) and the cleats 5100, 5106 can be disposed at an opposite end of the tool 5062 (e.g., shown as a lower end). As illustrated in FIG. 34, the cleat 5098 can include an interior stop surface 5098a, an exterior stop surface 5098b, a face surface 5098c, and an interface surface 5098d. The cleat 5100 can include an interior stop surface 5100a, an exterior stop surface 5100b, a face surface 5100c, and an interface surface 5100d. As illustrated in FIG. 35, the cleat 5104 can include an interior stop surface 5104a, an exterior stop surface 5104b, a face surface 5104c, and an interface surface 5104d. The cleat 5106 can include an interior stop surface 5106a, an exterior stop surface 5106b, a face surface 5106c, and an interface surface 5106d.

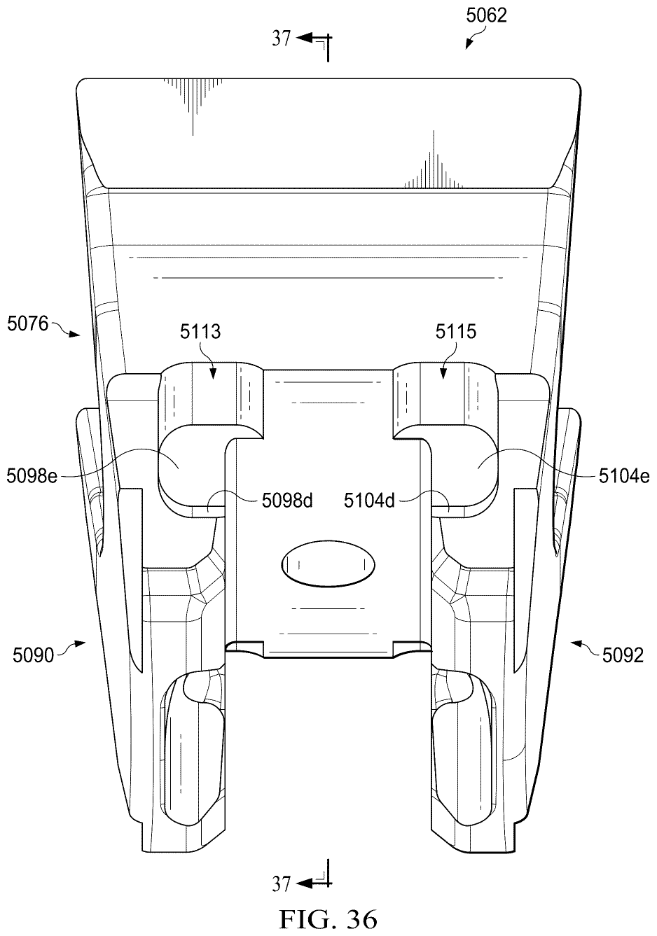

Referring now to FIG. 36, the interface surfaces 5098d, 5104d of the cleats 5098, 5104 can be adjacent to the main body 5076, and spaced therefrom, such that a portion of the first sidewall 5090 extends between the cleat 5098 and the main body 5076 and a portion of the second sidewall 5092 extends between the cleat 5104 and the main body 5076. An intermediate surface 5098e can extend between the interface surface 5098d and the main body 5076 and can cooperate with the main body 5076, the interface surface 5098d, and the first sidewall 5090 to define a receptacle 5113 adjacent to the cleat 5098. An intermediate surface 5104e can extend between the interface surface 5104d and the main body 5076 and can cooperate with the main body 5076, the interface surface 5104d, and the second sidewall 5092 to define a receptacle 5115 adjacent to the cleat 5104. Each of the receptacles 5113, 5115 can be disposed at the upper end of the tool 5062 to provide locations to receive cleat supports from the tool holder 5060 when the tool 5062 is installed on the tool holder 5060, as will be described in further detail below.

Referring again to FIG. 35, receptacles 5117, 5119 can be disposed at the lower end of the tool 5062 and can be similar to the receptacles 5113, 5115 described above. For example, as illustrated in FIG. 35, the receptacle 5117 can be adjacent to the cleat 5100 and defined by an intermediate surface 5100e, the interface surface 5100d, the main body 5076, and the first sidewall 5090. The receptacle 5119 can be adjacent to the cleat 5106 and defined by an intermediate surface 5106e, the interface surface 5106d, the main body 5076, and the second sidewall 5092.

Referring again to FIG. 34, the passageway 5082 can define a centerline C1 that resides in each of an imaginary vertical plane P1 and an imaginary horizontal plane P2 that are perpendicular to each other. The rear end 5094 of the tool 5062 can be vertically and horizontally symmetrical about the centerline C1. The main body 5076 can define an imaginary vertical plane P3 that is perpendicular to the centerline C1 and extends through a portion of a support surface 5096.

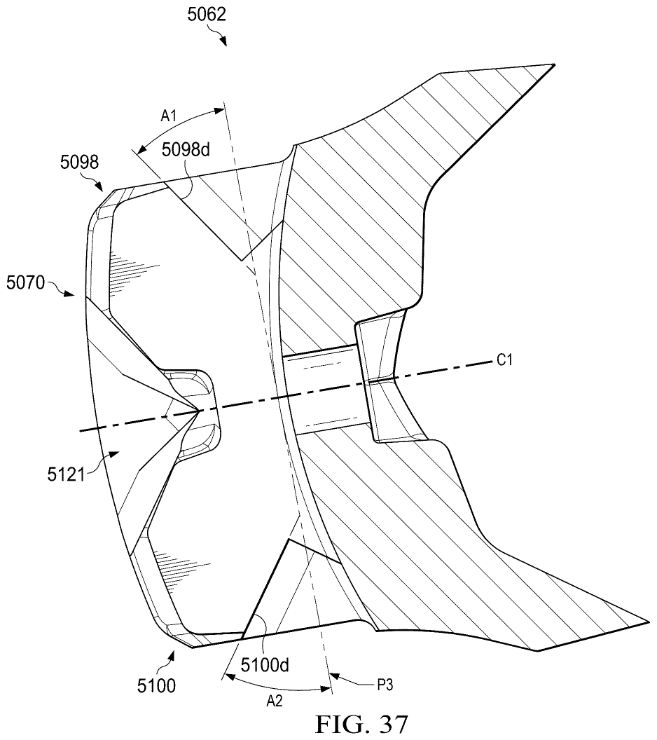

Referring now to FIG. 37, the interface surface 5098d of the cleat 5098 is shown to be angled away from the main body 5076 towards the rear end 5070 and the upper end such that the interface surface 5098d is at an oblique angle A1 with respect to the imaginary vertical plane P3. The angle of the interface surface 5098d can effectively result in the receptacle 5113 tapering inwardly as it extends away from the upper end of the tool 5062 (e.g., in the direction of the centerline C1). In one embodiment, the oblique angle A1 can be between about 40 degrees and 70 degrees and in one example about 55 degrees. As will be described in further detail below, angling the interface surface 5098d in this manner can enhance the distribution of the forces imparted on the tool 5062 to the tool holder 5060.

The interface surface 5098d is shown to be substantially planar such that measuring the angle of the interface surface 5098d relative to the imaginary vertical plane P3 can be relatively straightforward. Alternative embodiments, however, are contemplated where the interface surface 5098d can be non-planar, such as when the interface surface 5098d includes surface discontinuities, contours, or other characteristics that contribute to the non-planarity of the interface surface 5098d. In these embodiments, a representative planar surface can be approximated for the non-planar interface surface 5098d using any of a variety of suitable techniques. The representative planar surface can then be used to measure the angle of the non-planar interface surface 5098d relative to the imaginary vertical plane P3. In one example, the representative planar surface can be approximated using a best-fit plane modeling algorithm that samples different points along the non-planar interface surface 5098d and approximates the representative planar surface using a regression analysis (e.g., a least squares regression analysis) or other suitable analysis method. It is to be appreciated that the measurement of the angle of any other surface described herein relative to the imaginary vertical plane P3 (or any other imaginary plane or other reference) can be understood to be achieved in a similar manner.

The interface surface 5100d of the cleat 5100 is shown to be angled away from the main body 5076 and towards the rear end 5070 and the lower end such that the interface surface 5100d is at an oblique angle A2 with respect to the imaginary vertical plane P3. The angle of the interface surface 5100d can effectively result in the receptacle 5117 tapering inwardly as it extends away from the lower end of the tool 5062 (e.g., in the direction of the centerline C1). In one embodiment, the oblique angle A2 can be between about 40 degrees and 70 degrees and in one example about 55 degrees. In one embodiment, the oblique angle of the interface surface 5100d can be substantially the same as the oblique angle of the interface surface 5098d.

Each of the cleats 5098, 5100 are shown to extend to the main body 5076 and to converge such that the cleats 5098, 5100 form a monolithic structure that projects rearwardly from the main body 5076 and inwardly from the first sidewall 5090. The cleats 5098, 5100, and more particularly the interior stop surfaces 5098a, 5100a, can cooperate to define a notch 5121 at the rear end 5070. The interior stop surfaces 5098a, 5100a can each be angled relative to each other and to the imaginary vertical plane P3 such that the notch 5121 is substantially V-shaped and tapers towards the front end 5080. In one embodiment, the oblique angles of the interface surfaces 5098a, 5100a can be substantially the same as the oblique angles of the interface surfaces 5098d, 5100d, respectively.

It is to be appreciated that the cleats 5106, 5104 can be configured similarly to the cleats 5098, 5100, respectively, but can instead be positioned on an opposite side of the tool 5062 and as a mirror image of the cleats 5098, 5100 (e.g., about the imaginary vertical plane P1 and/or the imaginary horizontal plane P2). As such, the respective angles of the interface surfaces 5106d, 5104d with respect to the imaginary plane P3 can be similar to the angles of the interface surfaces 5098d, 5100d. The cleats 5106, 5104 can also cooperate to define a notch 5123 (FIG. 35), via the interior stop surfaces 5106a, 5104a, at the rear end 5070.

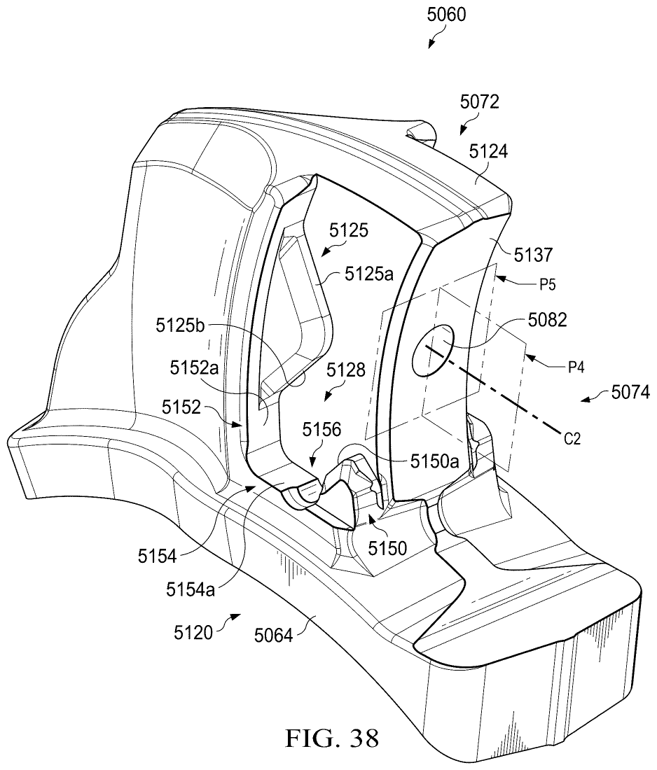

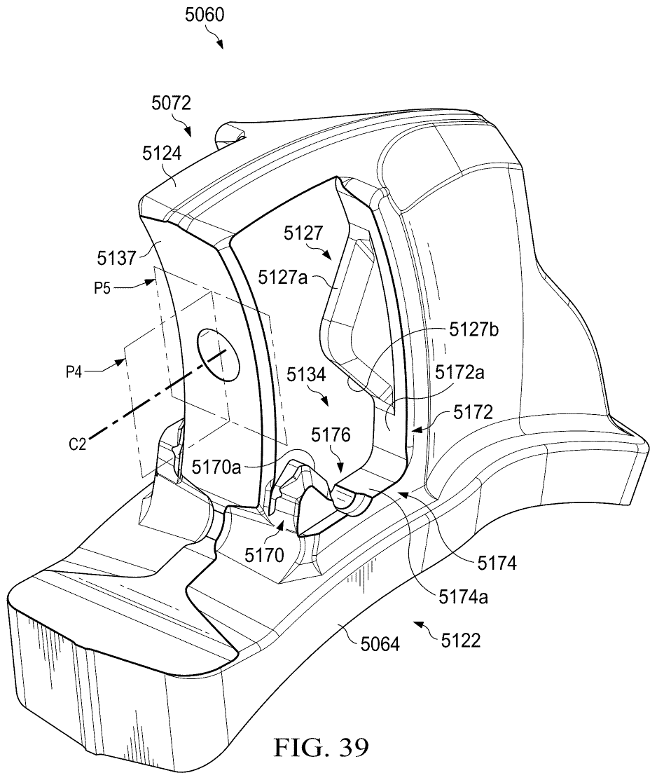

Referring now to FIGS. 38 and 39, the tool interface pillar 5072 can include a left side 5120 (FIG. 38), a right side 5122 (FIG. 39) and a main portion 5124 that at least partially defines the passageway 5082. The main portion 5124 can include a support surface 5137 that is disposed at a front end 5074 of the tool holder 5060. The passageway 5082 can define a centerline C2 that resides in an imaginary vertical plane P4 that extends along the main portion 5124 and bisects the tool interface pillar 5072 into the left and right sides 5120, 5122. The left and right sides 5120, 5122 can be symmetrical about the imaginary vertical plane P4 such that they are substantial mirror images of each other about the imaginary vertical plane P4. The main portion 5124 can define an imaginary vertical plane P5 that is perpendicular to the centerline C2 and extends through a portion of the support surface 5137.

As illustrated in FIG. 38, the tool interface pillar 5072 can include a left lower cleat support structure 5128 that includes a left cleat support 5150, a rear support portion 5152, and a lower support portion 5154. The left cleat support 5150 can be positioned in front of the rear support portion 5152 and spaced therefrom such that the lower support portion 5154 can extend therebetween. The left cleat support 5150 and the rear and lower support portions 5152, 5154 can cooperate with the main portion 5124 to define a slot 5156 for receiving one of the cleats. The rear support portion 5152 can include a rear surface 5152a and the lower support surface 5154 can include a lower surface 5154a. The left cleat support 5150 can include an interface surface 5150a that extends upwardly from the lower surface 5154a in front of the rear and lower surfaces 5152a, 5154a. The interface surface 5150a can be adjacent to the lower surface 5154a, and spaced therefrom, and the lower surface 5154a can extend between the interface and rear surfaces 5150a, 5152a.

The interface surface 5150a of the left cleat support 5150 can be angled away from the main body 5076 and towards a front end 5074 and an upper end such that the interface surface 5150a is at an oblique angle with respect to the imaginary vertical plane P5. The oblique angle of the interface surface 5150a can effectively result in the slot 5156 tapering inwardly as it extends towards a lower end of the tool holder 5060 (e.g., towards the base flange 5064 and away from the centerline C2). The oblique angle of the interface surface 5150a can substantially match the oblique angles of the interface surfaces 5098d, 5104d such that, when the tool 5062 is installed on the tool holder 5060 in either orientation, the interface surface 5150a can be flush against either of the interface surfaces 5098d, 5104d (depending on the orientation of the tool 5062). As such, in one embodiment, the oblique angle of the interface surface 5150a can be between about 40 degrees and 70 degrees and in one example can be about 55 degrees.

Still referring to FIG. 38, the tool interface pillar 5072 can include a left rear cleat support 5125 that extends forwardly from the rear portion 5068 and laterally from the main portion 5124 and is disposed rearwardly of the left cleat support 5150. The left rear cleat support 5125 can have a similar shape as the notches 5121, 5123 such that, when the tool 5062 is installed on the tool holder 5060 in either orientation, the left rear cleat support 5125 can fit into either of the notches 5121, 5123 (depending on the orientation of the tool 5062). The left rear cleat support 5125 can include an upper interface surface 5125a and a lower interface surface 5125b that are angled relative to each other and to the imaginary vertical plane P5 such that the left rear cleat support 5125 is substantially V-shaped and tapers towards the front end 5080. The upper and lower interface surfaces 5125a, 5125b can have oblique angles relative to the imaginary vertical plane P5 that match the oblique angles of the interior stop surfaces 5098a, 5100a of the notch 5121 and the oblique angles of the interior stop surfaces 5104a, 5106a of the notch 5123 such that, when the tool 5062 is installed on the tool holder 5060 in either orientation, the upper and lower interface surfaces 5125a, 5125b can be flush against either the interior stop surfaces 5098a, 5100a of the notch 5121 or the interior stop surfaces 5104a, 5106a of the notch 5123 (depending on the orientation of the tool 5062). As such, in one embodiment, the oblique angle of the upper and lower interface surfaces 5125a, 5125b can be between about 40 degrees and 70 degrees and in one example can be about 55 degrees.

As illustrated in FIG. 39, the tool interface pillar 5072 can include a right lower cleat support structure 5134 that includes a right cleat support 5170, a rear support portion 5172, and a lower support portion 5174. The right cleat support 5170 can be positioned in front of the rear support portion 5172 and spaced therefrom such that the lower support portion 5174 can extend therebetween. The right cleat support 5170 and the rear and lower support portions 5172, 5174 can cooperate with the main portion 5124 to define a slot 5176 for receiving one of the cleats. The rear support portion 5172 can include a rear surface 5172a and the lower support portion 5174 can include a lower surface 5174a. The right cleat support 5170 can include an interface surface 5170a that extends upwardly from the lower surface 5174a in front of the rear and lower surfaces 5172a, 5174a. The interface surface 5170a can be adjacent to the rear surface 154a, and spaced therefrom, and the lower surface 5174a can extend between the interface and rear surfaces 5170a, 5172a.

The interface surface 5170a of the right cleat support 5170 can be angled away from the main body 5076 and towards a front end 5074 and an upper end such that the interface surface 5170a is at an oblique angle with respect to the imaginary vertical plane P5. The oblique angle of the interface surface 5170a can effectively result in the slot 5176 tapering inwardly as it extends towards the lower end of the tool holder 5060 (e.g., away from the centerline C2). The oblique angle of the interface surface 5170a can substantially match the oblique angles of the interface surfaces 5100d, 5106d such that, when the tool 5062 is installed on the tool holder 5060 in either orientation, the interface surface 5170a can be flush against either of the interface surfaces 5100d, 5106d (depending on the orientation of the tool 5062). As such, in one embodiment, the oblique angle of the interface surface 5170a can be between about 40 degrees and 70 degrees and in one example can be about 55 degrees.

Still referring to FIG. 39, the tool interface pillar 5072 can include a right rear cleat support 5127 that extends forwardly from the rear portion 5068 and laterally from the main portion 5124 and is disposed rearwardly of the right cleat support 5170. The right rear cleat support 5127 can have a similar shape as the notches 5121, 5123 (FIGS. 34, 35) such that, when the tool 5062 is installed on the tool holder 5060 in either orientation, the right rear cleat support 5127 can fit into either of the notches 5121, 5123 (depending on the orientation of the tool 5062). The right rear cleat support 5127 can include an upper interface surface 5127a and a lower interface surface 5127b that are angled relative to each other and to the imaginary vertical plane P5 such that the right rear cleat support 5127 is substantially V-shaped and tapers towards the front end 5080. The upper and lower interface surfaces 5127a, 5127b can have oblique angles relative to the imaginary vertical plane P5 that match the oblique angles of the interior stop surfaces 5098a, 5100a of the notch 5121 and the oblique angles of the interior stop surfaces 5104a, 5106a of the notch 5123 such that, when the tool 5062 is installed on the tool holder 5060 in either orientation, the upper and lower interface surfaces 5127a, 5127b can be flush against either the interior stop surfaces 5098a, 5100a of the notch 5121 or the interior stop surfaces 5104a, 5106a of the notch 5123 (depending on the orientation of the tool 5062). As such, in one embodiment, the oblique angle of the upper and lower interface surfaces 5127a, 5127b can be between about 40 degrees and 70 degrees and in one example can be about 55 degrees.

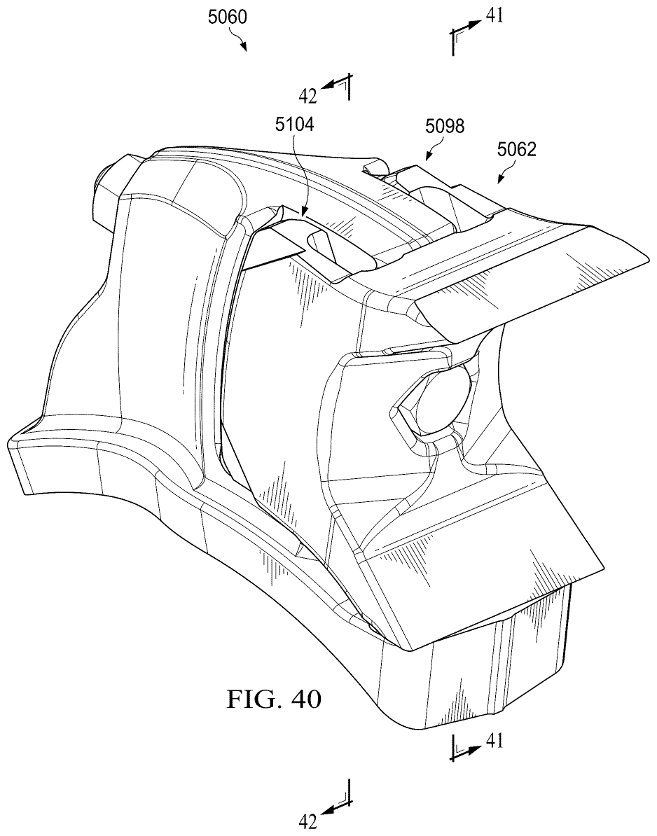

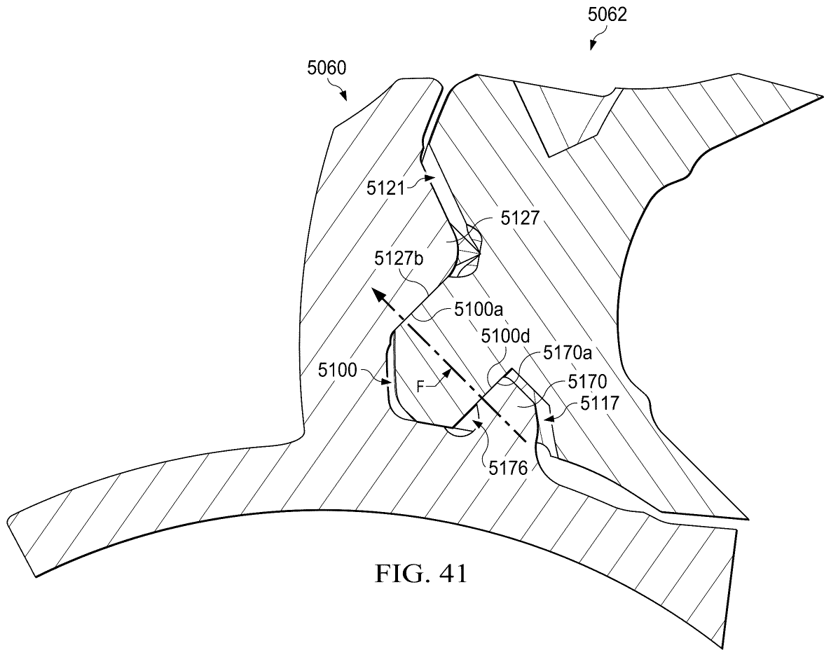

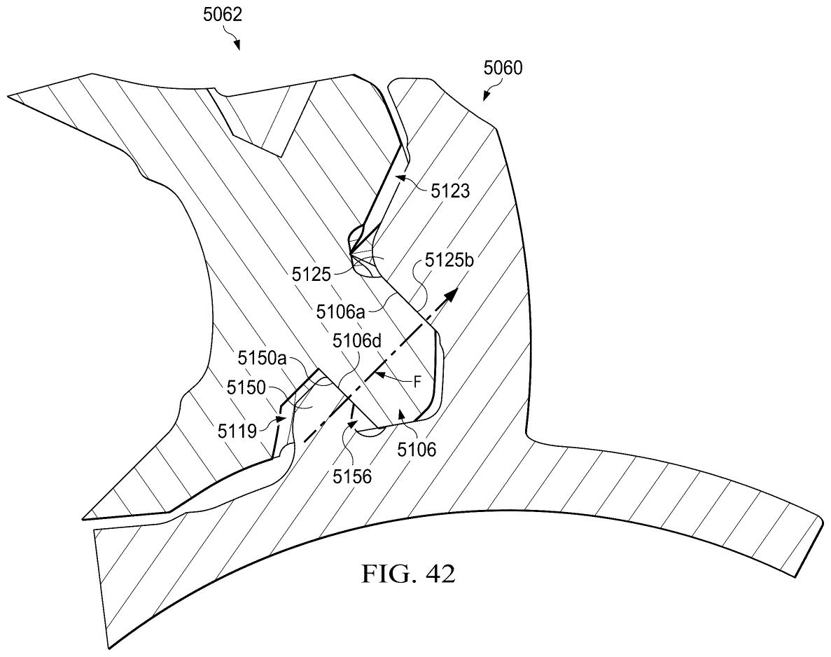

Referring now to FIGS. 40-42, the tool 5062 is shown to be installed on the tool holder 5060 in a first orientation with the cleats 5100, 5106 (not shown) installed on the right and left lower cleat support structures 5134, 5128 (not shown), respectively. FIGS. 41 and 42 are right and left cross sectional views of FIG. 40 that illustrate how the tool 5062 and the tool holder 5060 interface with each other. As illustrated in FIG. 41, the cleat 5100 can extend into the slot 5176, the right cleat support 5170 can extend into the receptacle 5117, and the right rear cleat support 5127 cleat extend into the notch 5121 such that the cleat 5100 is effectively wedged between the right cleat support 5170 and the right rear cleat support 5127. Because the interface surface 5100d of the cleat 5100 and the interface surface 5170a of the right cleat support 5170 are provided at substantially the same oblique angle, the interface surface 5100d and the interface surface 5170a can be substantially flush against each other. Similarly, because the interior stop surface 5100a of the cleat 5100 and the lower interface surface 5127b of the right rear cleat support 5127 are provided at substantially the same angle, the interior stop surface 5100a and the lower interface surface 5127b can be substantially flush against each other.

As illustrated in FIG. 42, the cleat 5106 can extend into the slot 5156, the left cleat support 5150 can extend into the receptacle 5119, and the left rear cleat support 5125 extend into the notch 5123 such that the cleat 5106 is effectively wedged between the left cleat support 5150 and the left rear cleat support 5125. Because the interface surface 5106d of the cleat 5106 and the interface surface 5150a of the left cleat support 5150 are provided at substantially the same angle, the interface surface 5106d and the interface surface 5150a can be substantially flush against each other. Similarly, because the interior stop surface 5106a of the cleat 5106 and the lower interface surface 5125b of the left rear cleat support 5125 are provided at substantially the same angle, the interior stop surface 5100a and the lower interface surface 5125b can be substantially flush against each other.

When the tool 5062 and tool holder 5060 impact material during a land clearing process (e.g., through rotation of the rotatable drum 38), a significant amount of the force from the impact can be imparted to the tool 5062 and tool holder 5060 generally along the force path F shown in FIGS. 41 and 42. By providing the surfaces 5100d, 5100a, 5106d, 5106a of the cleats 5100, 5106 flush against the surfaces 5170a, 5127b, 5150a, 5125b of the tool holder 5060, the surface area provided between the surfaces (e.g., 5100d and 5170a; 5100a and 5127b; 5106d and 5150a; 5106a and 5125b) can encourage the force to be more evenly distributed through the cleats 5100, 5106 and the tool holder 5060 along the force path F. The oblique angles of the surfaces 5100d, 5170a, 5100a, 5127b, 5106d, 5150a, 5106a, 5125b can be selected to enhance the distribution of force and in some configurations can be selected to be substantially perpendicular to the force path F. In one embodiment, the oblique angles of the surfaces 5100d, 5170a, 5100a, 5127b, 5106d, 5150a, 5106a, 5125b can be between about 40 degrees and about 70 degrees and in some examples about 55 degrees. It is to be appreciated that in instances where the surfaces 5100d, 5170a, 5100a, 5127b, 5106d, 5150a, 5106a, 5125b might be non-planar, adjacent surfaces that contact each other (e.g., 5100d and 5170a) can be complementary to one another such that the adjacent surfaces are still substantially flush when in contact with one another. It is also to be appreciated that the oblique angles of some of the adjacent pairs of the surfaces (e.g., 5100d and 5170a; 5100a and 5127b; 5106d and 5150a; 5106a and 5125b) can be different from of other adjacent pairs while maintaining the capabilities described herein.

When the tool 5062 is no longer serviceable (e.g., the upper blade is worn out) in the first orientation shown in FIGS. 40-42, the tool 5062 can be removed from the tool holder 5060 and installed on the tool holder 5060 in a second (inverted) orientation. When in the second orientation, the cleats 5098, 5104 can be installed on the left and right lower cleat support structures 5128, 5132, respectively, and can interface with the left and right lower cleat support structures 5128, 5132 in a similar manner as described above with respect to cleats 5100, 5106.

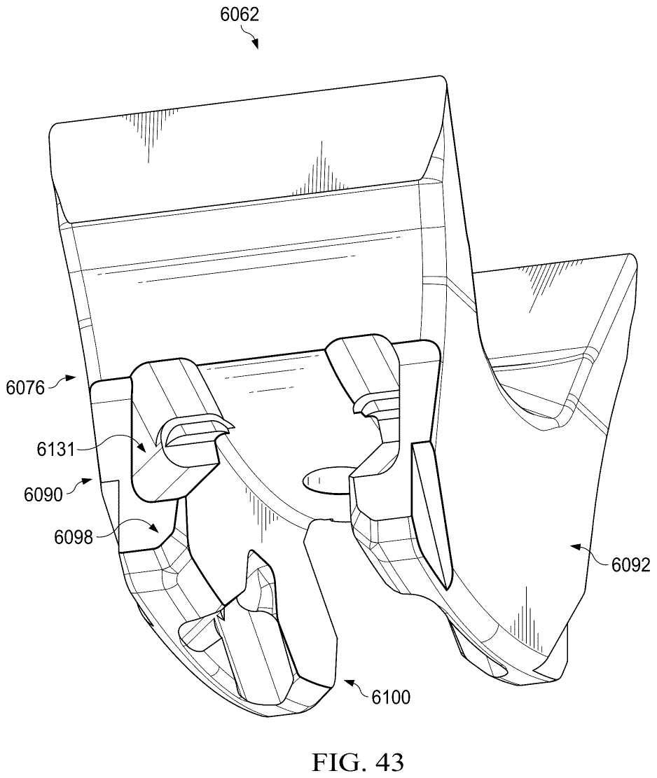

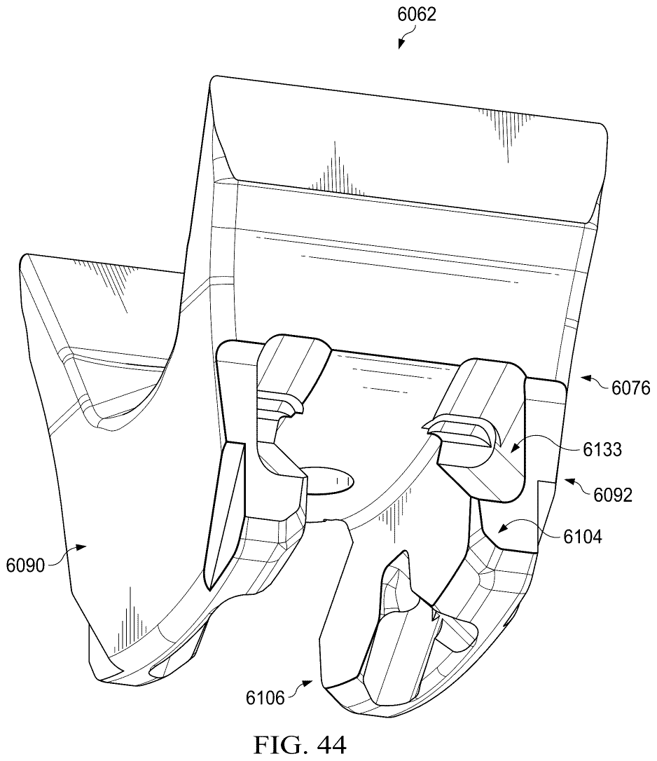

FIGS. 43 and 44 illustrate an alternative embodiment of a tool 6062 that is similar to, or the same in many respects as the tool 5062 illustrated in FIGS. 32-42. For example, the tool 6062 can include first and second sidewalls 6090, 6092 that extend from a main body 6076. A pair of cleats 6098, 6100 extend inwardly from the first sidewall 6090 and a pair of cleats 6104, 6106 extend inwardly from the second sidewall 6092. The cleats 6098, 6100, 6104, 6106 are spaced from the main body 6076 such that a channel 6131 extends between the main body 6076 and the cleats 6098, 6100 (FIG. 43) and a channel 6133 extends between the main body 6076 and the cleats 6104, 6106 (FIG. 44).

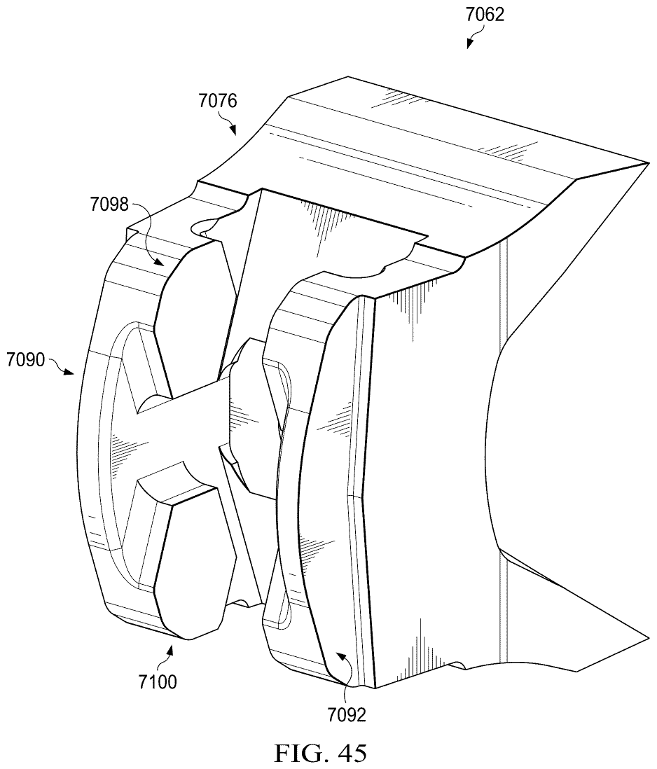

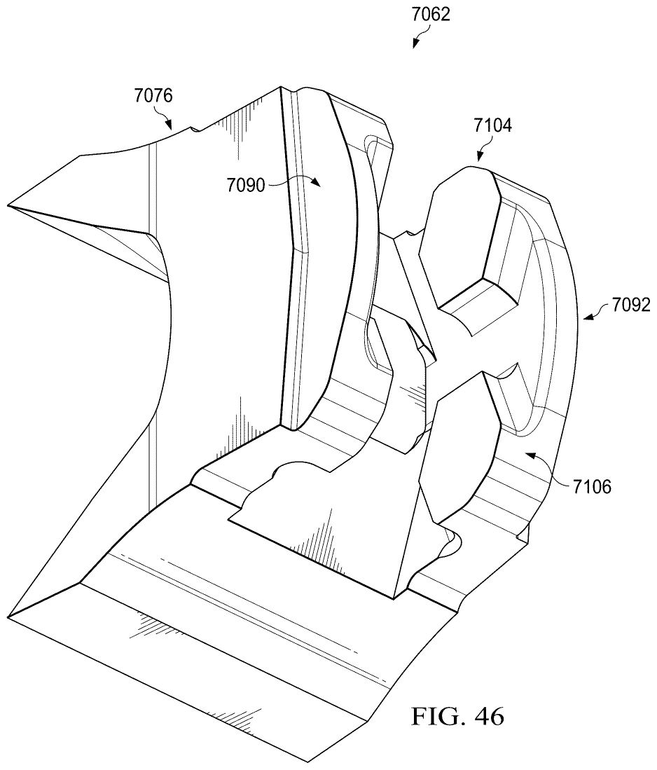

FIGS. 45 and 46 illustrate an alternative embodiment of a tool 7062 that is similar to, or the same in many respects as the tool 6040 illustrated in FIG. 32-42. For example, the tool 7062 can include first and second sidewalls 7090, 7092 that extend from a main body 7076. A pair of cleats 7098, 7100 extend inwardly from the first sidewall 7090 and a pair of cleats 7104, 7106 extend inwardly from the second sidewall 7092. However, the cleats 7098, 7100 are spaced from the main body 7076 and cleats 7104, 7106 are spaced from each other and the main body 7076.

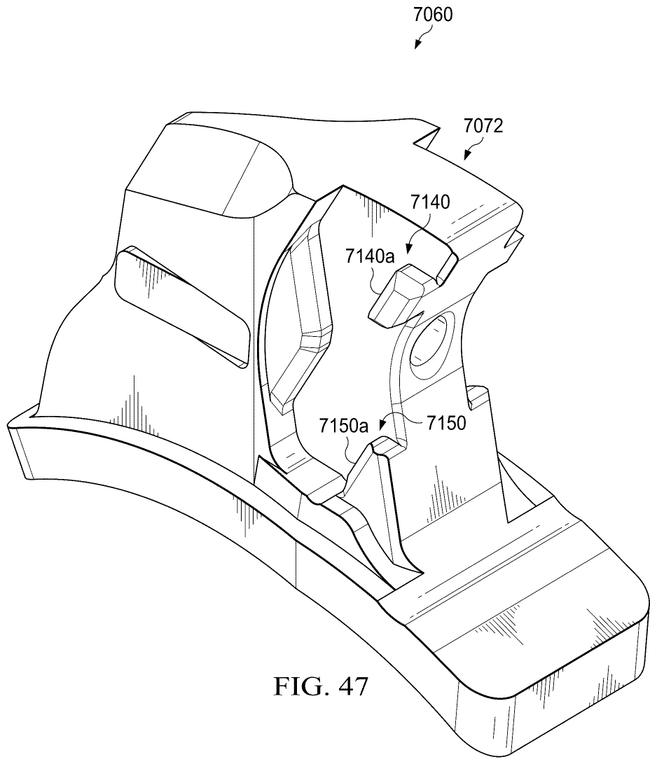

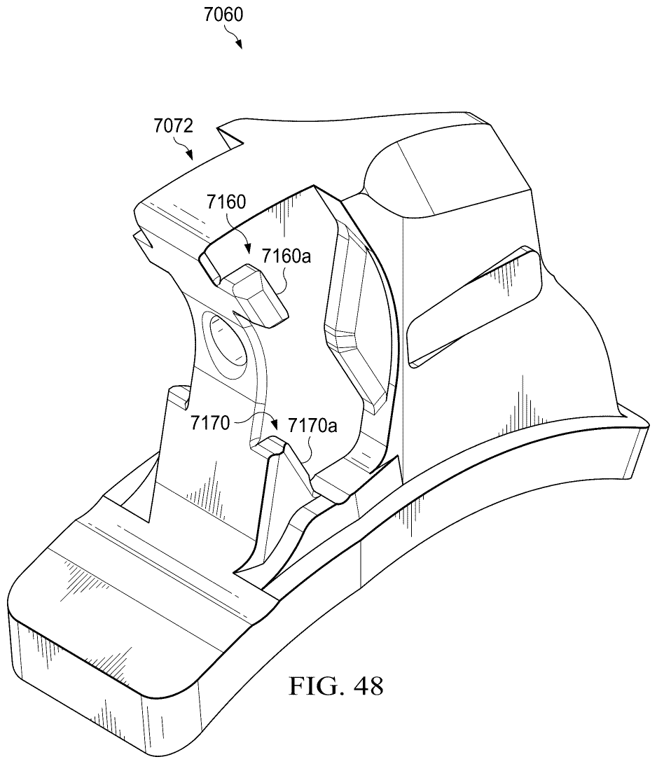

FIGS. 47 and 48 illustrate an alternative embodiment of a tool holder 7060 that is similar to, or the same in many respects as the tool holder 5060 illustrated in FIGS. 32-42. For example, the tool holder 7060 can include a left cleat support 7150 (FIG. 47) and a right cleat support 7170 (FIG. 48) that extend laterally outwardly from an interface pillar 7072 on opposite sides. However, the tool holder 7060 includes an upper left cleat support 7140 (FIG. 47) and an upper right cleat support 7160 (FIG. 48) that extend laterally outwardly from the interface pillar 7072 on opposite sides but that are vertically spaced from the left and right cleat supports 7150, 7170, respectively. The upper left and right cleat supports 7140, 7160 can include interface surfaces 7140a, 7160a that are angled in a similar manner as interface surfaces 7150a, 7170a of the left and right cleat supports 7150, 7170. In this configuration, when the tool 7062 illustrated in FIGS. 45 and 46 is installed on the tool holder 7060, the cleat supports 7140, 7150, 7160, 7170 can interface with the cleats 7098, 7100, 7104, 7106 (depending on the positioning of the tool 7062) to retain the tool 7062 on the tool holder 7060.

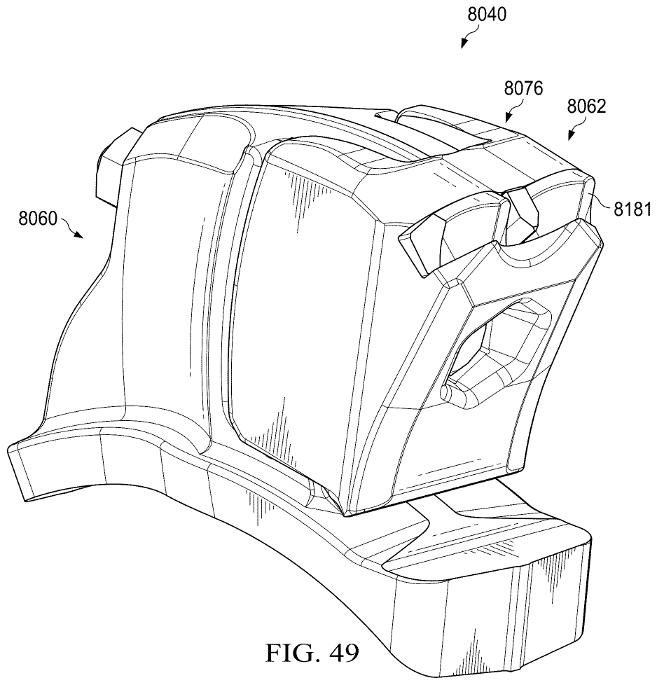

FIG. 49 illustrates yet another alternative embodiment of a tool assembly 8040 that is similar to, or the same in many respects as the tool assembly 5040 illustrated in FIGS. 32-42. For example, the tool assembly 8040 can include a tool holder 8060 and a tool 8062. The tool 8062, however, can include a carbide tip 8081 that is attached to a main body 8076.

It is noted that terms like “specifically,” “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended that the scope be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

1. A tool for a rotary land preparation implement, the tool having a front end and a rear end and comprising:
a main body;
at least one material engaging feature associated with the main body and disposed at the front end;
a first sidewall extending from the main body at the rear end;
a second sidewall extending from the main body at the rear end and spaced from the first sidewall;
a first cleat disposed at a lower end of the tool and extending from the first sidewall towards the second sidewall, the first cleat being spaced from the second sidewall; and
a second cleat disposed at the lower end of the tool and extending from the second sidewall towards the first sidewall, the second cleat being spaced from the first sidewall and the first cleat, wherein:
the first cleat comprises a first interface surface adjacent the main body and that cooperates with the main body to at least partially define a first receptacle that extends through the lower end of the tool;
the second cleat comprises a second interface surface adjacent the main body and that cooperates with the main body to at least partially define a second receptacle that extends through the lower end of the tool;
the first receptacle and the second receptacle are configured to accommodate at least one cleat support of a tool holder to facilitate retention of the tool to the tool holder;
the first interface surface is angled away from the main body such that the first receptacle tapers inwardly as it extends away from the lower end; and
the second interface surface is angled away from the main body such that the second receptacle tapers inwardly as it extends away from the lower end.

2. The tool of claim 1 further comprising:
a first intermediate surface that extends between the first interface surface and the main body and further defines the first receptacle; and
a second intermediate surface that extends between the second interface surface and the main body and further defines the second receptacle.

3. (canceled)

4. The tool of claim 1, wherein:
the main body defines a horizontal centerline that extends between the front end and rear end of the tool;
the main body defines an imaginary vertical plane that is perpendicular to the horizontal centerline;
the first interface surface is at a first oblique angle with respect to the imaginary vertical plane; and
the second interface surface is at a second oblique angle with respect to the imaginary vertical plane.

5. The tool of claim 4 wherein the first oblique angle and the second oblique angle are between about 40 degrees and about 70 degrees.

6. The tool of claim 5 wherein the first oblique angle and the second oblique angle are about 55 degrees.

7. The tool of claim 5 wherein the first oblique angle and the second oblique angle are substantially the same.

8. The tool of claim 4 wherein the main body comprises a support surface that is disposed between the first sidewall and the second sidewall.

9. The tool of claim 8 wherein the support surface is arcuate relative to the imaginary vertical plane.

10. The tool of claim 1 further comprising:
a third cleat disposed at an upper end of the tool and extending from a third sidewall towards a fourth sidewall, the third cleat being spaced from the fourth sidewall; and
a fourth cleat disposed at the upper end of the tool and extending from the fourth sidewall towards the third sidewall, the fourth cleat being spaced from the third sidewall and the third cleat, wherein:
the third cleat comprises a third interface surface adjacent the main body and that cooperates with the main body to at least partially define a third receptacle that extends through the upper end of the tool;
the fourth cleat comprises a fourth interface surface adjacent the main body and that cooperates with the main body to at least partially define a fourth receptacle that extends through the upper end of the tool; and
the third receptacle and the fourth receptacle are configured to accommodate the at least one cleat support of the tool holder to facilitate retention of the tool to the tool holder.

11. The tool of claim 10 further comprising:
a third intermediate surface that extends between the third interface surface and the main body and further defines the third receptacle; and
a fourth intermediate surface that extends between the fourth interface surface and the main body and further defines the fourth receptacle.

12. The tool of claim 10 wherein:
the first interface surface is angled away from the main body such that the first receptacle tapers away from the lower end;
the second interface surface is angled away from the main body such that the second receptacle tapers away from the lower end;
the third interface surface is angled away from the main surface such that the third receptacle tapers away from the lower end; and
the fourth interface surface is angled away from the main surface such that the fourth receptacle tapers away from the lower end.

13. The tool of claim 12, wherein:
the main body defines a horizontal centerline that extends between the front end and rear end of the tool;
the main body defines an imaginary vertical plane that is perpendicular to the horizontal centerline;
the first interface surface is at a first oblique angle with respect to the imaginary vertical plane; and
the second interface surface is at a second oblique angle with respect to the imaginary vertical plane;
the third interface surface is at a third oblique angle with respect to the imaginary vertical plane; and
the fourth interface surface is at a fourth oblique angle with respect to the imaginary vertical plane.

14. The tool of claim 13 wherein the first, second, third and fourth oblique angles are between about 40 degrees and about 70 degrees.

15. The tool of claim 14 wherein the first, second, third and fourth oblique angles are about 55 degrees.

16. The tool of claim 14 wherein the first, second, third and fourth oblique angles are substantially the same.

17. The tool of claim 10 wherein:
the main body defines a horizontal centerline that extends between the front end and rear end of the tool;
the main body defines an imaginary vertical plane that is perpendicular to the horizontal centerline;
the horizontal centerline resides in an imaginary horizontal plane that bisects the main body and is perpendicular to the imaginary vertical plane; and
the first and second receptacles are disposed on one side of the imaginary horizontal plane and the third and fourth receptacles are disposed on an opposite side of the imaginary horizontal plane.

18. A tool holder for a rotary land preparation implement, the tool holder having a front end and a rear end, the tool holder comprising:
a rear portion disposed at the rear end; and
a tool interface pillar disposed at the front end and extending from the rear portion, the tool interface pillar comprising:
a main portion;
a left cleat support that extends laterally outwardly from the main portion on a left side of the tool interface pillar; and
a right cleat support that extends laterally outwardly from the main portion on a right side of the tool interface pillar, wherein:
the left cleat support comprises a left interface surface adjacent the rear portion and that cooperates with the rear portion to at least partially define a left slot that is configured to receive a left cleat of a tool;
the right cleat support comprises a right interface surface adjacent the rear portion and that cooperates with the rear portion to at least partially define a right slot that is configured to receive a right cleat of the tool; and
the rear portion extends upwardly with respect to the left cleat support and the right cleat support.

19. The tool holder of claim 18 further comprising:
a left lower surface that extends between the left interface surface and the rear portion and further defines the left slot; and
a right lower surface that extends between the right interface surface and the rear portion and further defines the right slot.

20. The tool holder of claim 18 wherein:
the left interface surface is angled away from the rear portion such that the left slot tapers towards a lower end of the tool holder; and
the right interface surface is angled away from the rear portion such that the right slot tapers towards the lower end of the tool holder.

21. The tool holder of claim 20, wherein:
the rear portion defines a horizontal centerline that extends between the front end and rear end of the tool holder;
the rear portion defines an imaginary vertical plane that is perpendicular to the horizontal centerline;
the left interface surface is at a first oblique angle with respect to the imaginary vertical plane; and
the right interface surface is at a second oblique angle with respect to the imaginary vertical plane.

22. The tool holder of claim 21 wherein the first oblique angle and the second oblique angle are between about 40 degrees and about 70 degrees.

23. The tool holder of claim 22 wherein the first oblique angle and the second oblique angle are about 55 degrees.

24. The tool holder of claim 22 wherein the first oblique angle and the second oblique angle are substantially the same.

25. The tool holder of claim 18 further comprising:
a left rear cleat support that extends laterally outwardly from the main portion on a left side of the tool interface pillar rearwardly of the left cleat support; and
a right rear cleat support that extends laterally outwardly from the main portion on a right side of the tool interface pillar rearwardly of the right cleat support.

26. The tool holder of claim 25 wherein:
the left rear cleat support comprises an upper interface surface and a lower interface surface that are angled with respect to each other; and
the right rear cleat support comprises an upper interface surface and a lower interface surface that are angled with respect to each other.

27. A rotary land preparation implement comprising:
a tool having a front end and a rear end, the tool comprising:
a main body;
at least one material engaging feature associated with the main body and disposed at the front end;
a first sidewall extending from the main body at the rear end;
a second sidewall extending from the main body at the rear end and spaced from the first sidewall;
a first cleat disposed at a lower end of the tool and extending from the first sidewall towards the second sidewall, the first cleat being spaced from the second sidewall; and
a second cleat disposed at the lower end of the tool and extending from the second sidewall towards the first sidewall, the second cleat being spaced from the first sidewall and the first cleat;
a tool holder having a front end and a rear end, the tool holder comprising:
a rear portion disposed at the rear end; and
a tool interface pillar disposed at the front end and extending from the rear portion, the tool interface pillar comprising:
a main portion;
a left cleat support that extends laterally outwardly from the main portion on a left side of the tool interface pillar; and
a right cleat support that extends laterally outwardly from the main portion on a right side of the tool interface pillar, wherein:
the first cleat comprises a first interface surface adjacent the main body and that cooperates with the main body to at least partially define a first receptacle that extends through the lower end of the tool;
the second cleat comprises a second interface surface adjacent the main body and that cooperates with the main body to at least partially define a second receptacle that extends through the lower end of the tool;
the first interface surface is angled away from the main body such that the first receptacle tapers inwardly as it extends away from the lower end; and
the second interface surface is angled away from the main body such that the first receptacle tapers inwardly as it extends away from the lower end;
the left cleat support comprises a left interface surface adjacent the rear portion and that cooperates with the rear portion to at least partially define a left slot that is configured to receive a left cleat of a tool;
the right cleat support comprises a right interface surface adjacent the rear portion and that cooperates with the rear portion to at least partially define a right slot that is configured to receive a right cleat of a tool;
the rear portion extends upwardly with respect to the left cleat support and the right cleat support; and
the first receptacle and the second receptacle are configured to accommodate opposing ones of the left cleat support and the right cleat support to facilitate retention of the tool to the tool holder.

28. The rotary land preparation implement of claim 27 further comprising:
a first intermediate surface that extends between the first interface surface and the main body and further defines the first receptacle; and
a second intermediate surface that extends between the second interface surface and the main body and further defines the second receptacle.
